(19) United States
(12) Patent Application Publication
(10) Pub. No.: US 2016/0044393 A1
(43) Pub. Date: Feb. 11, 2016

(54) System and Method for Photonic Networks

(71) Applicant: Futurewei Technologies, Inc., Plano, TX (US)

(72) Inventor: Alan Frank Graves, Kanata (CA)

(21) Appl. No.: 14/455,034

(22) Filed: Aug. 8, 2014

(51) Int. Cl. H04Q 11/00

(52) U.S. Cl. CPC H04Q 11/0005; H04Q 11/0003; H04Q 2011/0022

(57) ABSTRACT

In one embodiment, a photonic switching fabric includes a first stage including a plurality of first switches and a second stage including a plurality of second switches, where the second stage is optically coupled to the first stage. The photonic switching fabric also includes a third stage including a plurality of third switches, where the third stage is optically coupled to the second stage, where the photonic switching fabric is configured to receive a packet having a destination address, where the destination address includes a group destination address, and where the second stage is configured to be connected in accordance with the group destination address.

### TECHNICAL FIELD

The present invention relates to a system and method for communications, and, in particular, to a system and method for photonic networks.

### BACKGROUND

Data centers route massive quantities of data. Currently, data centers may have a throughput of 5-7 terabytes per second, which is expected to drastically increase in the future. Data centers consist of huge numbers of racks of servers, racks of storage devices and other racks, all of which are interconnected via a massive centralized packet switching resource. In data centers, electrical packet switches are used to route all data packets, irrespective of packet properties, in these data centers.

The racks of servers, storage, and input-output functions contain top of rack (TOR) packet switches which combine packet streams from their associated servers and/or other peripherals into a lesser number of very high speed streams per TOR switch routed to the electrical packet switching core switch resource. The TOR switches receive the returning switched streams from that resource and distribute them to servers within their rack. There may be 4×40 Gb/s streams from each TOR switch to the core switching resource, and the same number of return streams. There may be one TOR switch per rack, with hundreds to tens of thousands of racks, and hence hundreds to tens of thousands of TOR switches in a data center. There has been a massive growth in data center capabilities, leading to massive electronic packet switching structures.

### SUMMARY

An embodiment photonic switching fabric includes a first stage including a plurality of first switches and a second stage including a plurality of second switches, where the second stage is optically coupled to the first stage. The photonic switching fabric also includes a third stage including a plurality of third switches, where the third stage is optically coupled to the second stage, where the photonic switching fabric is configured to receive a packet having a destination address, where the destination address includes a group destination address, and where the second stage is configured to be connected in accordance with the group destination address.

An embodiment method of controlling a photonic switch includes identifying a destination group of a packet and selecting a wavelength for the packet in accordance with the destination group of the packet. The method also includes detecting an output port collision between the packet and another packet after determining the wavelength for the packet.

An embodiment method of generating a connection map for a photonic switching fabric includes performing a first step of connection map generation for a first packet to produce a first output and performing a second step of connection map generation for the first packet in accordance with the first output to produce a second output after performing the first step of connection map generation for the first packet. The method also includes performing the first step of connection map generation for a second packet at the same time as performing the second step of connection map generation for the first packet.

An embodiment photonic switching system includes a first input stage switching module and a first control module coupled to the first input stage switching module, where the first control module is configured to control the first input stage switching module. The photonic switching system also includes a second input stage switching module and a second control module coupled to the second input switching module, where the second control module is configured to control the second input stage switching module. Additionally, the photonic switching system includes a first output stage switching module and a third control module coupled to the output stage switching module, where the third control module is configured to control the first output stage switching module. Also, the photonic switching system includes a second output stage switching module and a fourth control module coupled to the second output stage switching module, where the fourth control module is configured to control the second output stage switching module. The photonic switching system also includes an orthogonal mapper coupled between the first control module, the second control module, the third control module, and the fourth control module.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment system for packet stream routing;

FIG. 2 illustrates another embodiment system for packet stream routing;

FIG. 3 illustrates an embodiment system for photonic packet processing;

FIG. 4 illustrates another embodiment system for photonic packet processing;

FIG. 5 illustrates a graph of cumulative density function (CDF) versus packet size;

FIG. 6 illustrates a graph of percentage of traffic in packets smaller than N versus packet size;

FIGS. 7A-7C illustrate graphs of overall node capacity gain and aggregate padding efficiency versus packet length threshold;

FIG. 8 illustrates an embodiment photonic switch matrix;

FIG. 9 illustrates an embodiment array waveguide router (AWG-R);

FIG. 10 illustrates a graph of transmissivity versus wavelength for an AWG-R;

FIG. 11 illustrates a transfer function of an AWG-R;

FIG. 12 illustrates an embodiment CLOS switch;

FIG. 13 illustrates another embodiment CLOS switch;

FIG. 14 illustrates an embodiment three stage photonic CLOS switch;

FIG. 15 illustrates another embodiment three stage photonic CLOS switch;

FIGS. 16A-16B illustrate an embodiment photonic circuit switching fabric and control system;

FIG. 17 illustrates an embodiment photonic switching fabric;

FIG. 18 illustrates a flowchart for an embodiment method of connecting a top of rack (TOR) group to another TOR group;

FIGS. 19A-19B illustrate an embodiment orthogonal message mapper;

FIGS. 20A-20B illustrate graphs of the probability of exceeding a given number of simultaneous connection attempts as a function of traffic level;

FIGS. 21A-21C illustrate an embodiment photonic switching path;

FIG. 22 illustrates a flowchart of an embodiment method of photonic switching; and

FIG. 23 illustrates a flowchart for an embodiment method of controlling a photonic switching fabric.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. Reference to data throughput and system and/or device capacities, numbers of devices, and the like is purely illustrative, and is in no way meant to limit scalability or capability of the embodiments claimed herein.

Instead of using a fully photonic packet switch or an electronic packet switch, a hybrid approach may be used. The packets are split into two data streams, one with long packets carrying most of the packet bandwidth, and another with short packets. The long packets are switched by a photonic switch, while the short packets are switched by another packet switch, which may be an electronic packet switch.

The splitters and combiners in the hybrid node route approximately 5-20% of the traffic bandwidth to electronic short packet switch and 80-95% of the bandwidth to a photonic long packet switching fabric, depending on the placement of the long/short splitting threshold. Packets with lengths below a threshold are switched by the electronic short packet switching fabric, and packets with lengths at or above the threshold are switched by the photonic switching fabric. Because the traffic in a data center tends to be bimodal, with a large amount of the traffic close to or at the maximum packet length or at a fairly small packet size, the long packet switch can be implemented with a very fast synchronous circuit switch when the packets of the long packet stream are all padded to a maximum length without excessive bandwidth inefficiencies from the addition of the padding.

It is desirable for the photonic switch to be synchronous with a frame length of the longest packet, leading to a very fast frame rate, because the frame payload capacity may be efficiently utilized without waiting for multiple packets for the same destination to be collected and assembled. The photonic switch may be implemented as a fast photonic space switch. This leads to a fixed duration for the packets being switched, with the packets in all inputs being switched starting and ending at the same time in the frame slots across the ports of the switch. As a result, the switch is clear of traffic from the previous frame before a new frame of packets is switched, and there is no frame-to-frame interaction with respect to available paths. In other words, there is no prior traffic for the new connections to avoid colliding with.

An embodiment creates a very high throughput node to switch packet traffic, where the traffic is split into packet flows of differing packet lengths and flowing to either use electronic or photonic switching, depending on the size of the packets in the streams, and each technology platform addresses the shortcomings of the other technology. Electronic switching, including electronic packet switching, may be very agile and responsive, but suffers from bandwidth limitations. On the other hand, photonic switching is far less limited by bandwidth considerations, but many of the functions required for fast agile switching of packets, especially short packets, are problematic. However, moderately fast set up time (1-5 ns) photonic circuit switches with large throughputs utilizing multi-stage photonic switch fabrics may be used. Hence, packet streams to be switched are split into separate streams of short packets and long packets. Short packets, while numerous, constitute 5-20% of the overall traffic bandwidth, while long packets have a much larger duration per packet, and constitute the remaining 80-95% of the bandwidth. The lesser bandwidth of the short packet streams may be switched by an agile electronic solution while the bulk of the bandwidth is switched by a photonic switch providing a much higher overall throughput. Additional details on such a system are included in U.S. patent application Ser. No. 13/902,008 filed on May 24, 2013, and which application is hereby incorporated herein by reference.

An embodiment switches long packets in a photonic switching path. The photonic switching of long packets in a fast photonic circuit switch is performed using a photonic circuit switch with multiple stages.

Fast circuit switches have stage-to-stage interactions which often involve complex processes to determine changes in connection maps or generate new connection maps. These processes become cumbersome when the switching fabric is not fully non-blocking and some connections may be re-routed to facilitate others being set up. In the case of a non-blocking switch, for example created by dilating (enlarging) the second stage, connections may be set up independently. Once set up, the connections are never re-routed to allow for additional connections, because there is always a free path available for those additional connections. However, it may be a challenge is to find the available free path quickly.

Fast circuit switches use a modified or new connection map for every switching event. For a fast circuit switch for packet traffic, a new or modified connection map is determined for every packet switched. This may be simplified by making the switching synchronous, and hence framed (having a repetitive timing period as the start, duration and end of the events that are synchronized), because a complete suite of new packets may be connection processed at once for each frame without regard to the connections already in existence because, in a synchronous approach, there are no previous connections in place because the previous frame's traffic has already been completely switched. However the synchronous operation leads to fixed length packets or packet containers. Because the vast majority of long packets are close to the maximum length, or are at the maximum length, with only a small proportion (5-15%) well away from maximum length (but still above the threshold length), padding out all packets to the same maximum length is not a major issue in terms of bandwidth efficiency. Hence, the photonic switch may be operated as a fast synchronous circuit switch with a very fast frame rate—120 ns for 1500 byte maximum length packets at 100 Gb/s, or 300 ns for the same packets at 40 Gb/s or 720 ns for “jumbo” packets of up to 9,000 bytes maximum at 100 Gb/s. This entails a new connection map for every switch frame, which equals a padded packet period—120 ns for 100 Gb/s 1500 byte packets.

Computing an approximately 1000×1000 port connection map, including resolving output port contention within 120 ns, may be problematic, especially in a non-hierarchical approach. In one example, the address is hierarchically broken down into groups and TOR addresses within those groups, so particular first stage modules and third stage modules constitute addressing groups which are associated with groups of TORs.

To make a connection from a TOR of one group to a TOR of another group, part of the connection processing establishes group-to-group connectivity. Because there are significantly fewer groups than there are TORs, this is simpler. In an embodiment switch, this task becomes the determination of the source group and destination group of source and destination TORs, and from these two group addresses, looking up and applying a wavelength value. This is facilitated by linking address grouping to groups of physical switch modules and treating each module's ports in the group as addressing groups. Then, the connectivity of the TORs of each group within that group is determined, which is a much smaller connection field than the overall connection map.

The overall connection map generation processing is broken down into sequential steps in a pipelined approach where a particular pipeline element performs its part of the overall task of connection processing of an address field and hands off its results to the next element in the pipeline within one frame period, so the first element may repeat its assigned task on the next frame's connections. This continues until the connection map for a complete frame's worth of connections is completed. This chain of elements constitutes a pipeline. The result of this process is that a series of complete connection maps emerges from this pipeline of processing elements, each element of which has performed its own optimized function. These resultant connection maps are generated and released for the frames and emerge from the pipeline spaced in time by one frame period but are delayed in time by m frames, where m equals the number of steps or series elements in the pipeline.

The complexity of the constituent processing elements of the pipeline are broken down so they are each associated with a particular input group (a particular first stage module) or a particular output group (a particular third stage module), and not using elements for processing across the entire node. This is achieved by using multiple parallel elements, each allocated to an input group or an output group.

Input group related information is used by output groups and vice versa, but this information is orthogonal, where each first stage processing element may send information across the parallel third stage oriented elements, and vice versa. This is achieved by mapping input related and output related information through a fast hardware based orthogonal mapper.

This creates a control structure implemented as a set of parallel group-oriented pipelines with fast orthogonal hardware based mappers for translation between first stage oriented pipeline elements and third stage oriented pipeline elements, resulting in a series/parallel array of small simple steps each of which may be implemented very rapidly.

Tapping off the connection addressing information occurs early in the overall packet length splitter/buffering/padding/acceleration process so the connection map computation delay is in parallel with the delays of the traffic path due to the operation of the buffer/padder and packet (containerized packet) accelerator functions, and the overall delay is reduced to the larger of these two activities rather than the sum of these two activities.

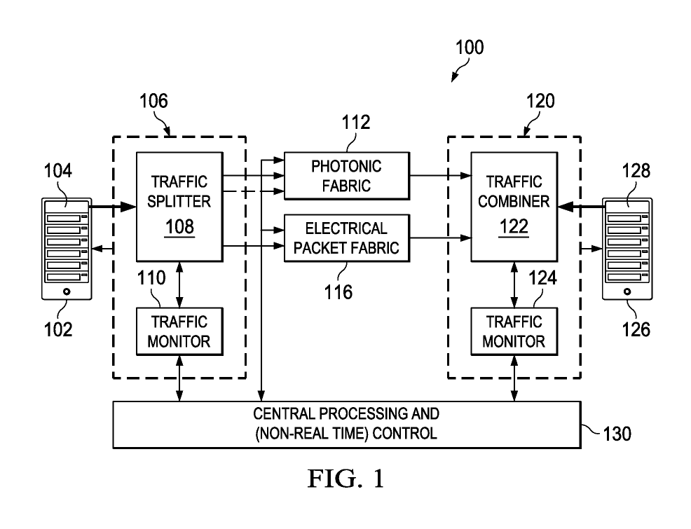

FIG. 1 illustrates system 100 for packet stream routing. Some packets are routed through electrical packet switches, while other packets are routed through photonic switches. For example, short packets may be switched by electrical packet switches, while long packets are switched by photonic switches. By only switching long packets, the photonic packet switching speed is relatively relaxed, because the packet duration is long, but the majority of the bandwidth is still handled photonically. In an example, long packets may have a variable length, and the photonic switch uses asynchronous switching. However, this leads to the consideration of prior traffic which may still be propagating through the switch when setting up a new connection, leading to a slower, more complex connection set up processing. Alternatively, long packets may be transmitted as fixed length packets by padding them to a fixed length, for example 1500 bytes. This is only slightly less bandwidth-efficient than the asynchronous approach, because most of the long packets are either at the fixed maximum length or are very close to that length due to the bimodal nature of the packet length distribution, whereby the majority of packets are either very short (<200 bytes) and are switched electronically or by other means through a short packet switch or are very long (>1200 bytes) and are switched photonically, with very few packets in the intermediate 200-1200 byte size range. Then, the photonic switch may use synchronous switching using a fast set up photonic circuit switch or burst switch.

Splitter 106 may be housed in TOR switch 104 in rack 102. Alternatively, splitter 106 may be a separate unit. There may be thousands of racks and TOR switches. Splitter 106 contains traffic splitter 108, which splits the packet stream into two traffic streams, and traffic monitor 110, which monitors the traffic. Splitter 106 may add identities to the packets based on their sequencing within each packet flow of a packet stream to facilitate maintaining the ordering of packets in each packet flow which may be taking different paths when they are recombined. Alternatively, packets within each packet flow may be numbered or otherwise individually identified before reaching splitter 106, for example using a packet sequence number or transmission control protocol (TCP) timestamps. One packet stream is routed to photonic switching fabric 112, while another packet stream is routed to electrical packet switching fabric 116. In an example, long packets are routed to photonic switching fabric 112, while short packets are routed to electrical packet switching fabric 116. Photonic switching fabric 112 may have a set up time of about one to twenty nanoseconds. The set up time, being significantly quicker than the packet duration of a long packet (1500 bytes at 100 Gb/s is 120 ns), does not seriously affect the switching efficiency. However, switching short packets at this switching set up time would be problematic. For instance, 50 byte control packets at 100 Gb/s have a duration of about 4 ns, which is less than the median photonic switch set up time. Photonic switching fabric 112 may contain an array of solid state photonic switches, which may be assembled into a fabric architecture, such as Baxter-Banyan, Benes, or CLOS.

Also, photonic switching fabric 112 contains a control unit, and electrical packet switching fabric 116 contains centralized or distributed processing functions. The processing functions provide packet by packet routing through the fabric based on the signaling/routing information, either carried as a common channel signaling path or as a packet header or wrapper.

The switched packets of photonic switching fabric 112 and electrical packet switching fabric 116 are routed to traffic combiner 122. Traffic combiner 122 combines the packet streams while maintaining the original sequence of packets, for example based on timestamps or sequence numbers of the packets in each packet flow. Traffic monitor 124 monitors the traffic. Central processing and control unit 130 monitors and utilizes the output of traffic monitor 110 and traffic monitor 124. Also, central processing and control unit 130 monitors and provisions the control of photonic switching fabric 112 and electrical packet switching fabric 116, and provides non-real time control to photonic switching fabric 112. Traffic combiner 122 and traffic monitor 124 are in combiner 120, which may reside in TOR switches 128. Alternatively, combiner 120 may be a stand-alone unit.

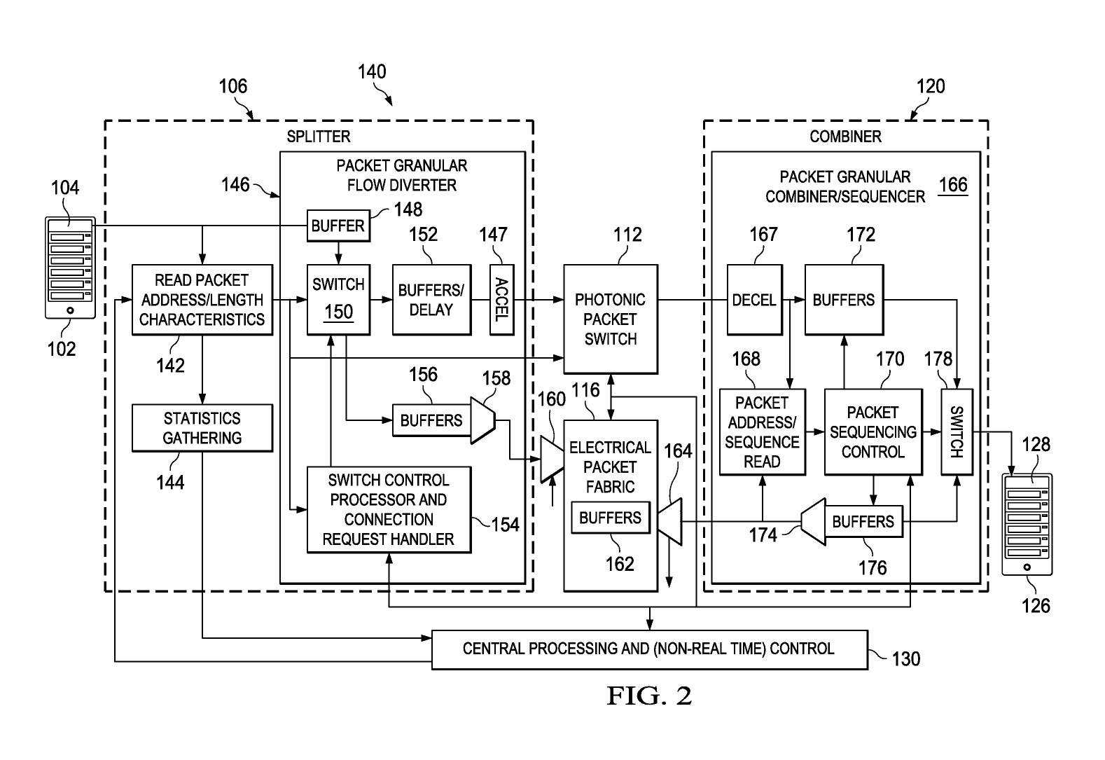

FIG. 2 illustrates system 140 for routing packet streams. System 140 is similar to system 100, but system 140 provides additional details of splitter 106 and combiner 120. Initially, the packet stream is fed to a buffer 148 in packet granular flow diverter 146, which diverts individual packets into the appropriate path based on a measured or detected packet attribute such as packet length, while read packet address and length characteristics module 142 determines the packet address and the length of the packet. The packet address and length are fed to statistics gathering module 144, which gathers statistics for control unit 130. Control unit 130 gathers statistics on the mix of packet lengths for non-real time uses, such as dynamic optimization of the packet size threshold value. Switch control processor and connection request handler 154 handles the real time packet-by-packet processes within packet granular flow diverter 146 including handling per-packet splitting of the packet stream into two streams based on the long/short packet threshold set by control unit 130. The packet stream that is buffered in buffer 148 then passes through packet granular flow diverter 146, which contains buffer 148, switch 150, buffer and delay 152, switch control processor and connection request handler 154, buffer 156, and statistical multiplexer 158, under control of switch control processor and connection request handler 154. Packet granular flow diverter 146 may optionally contain accelerator 147, which accelerates the packet in time and increases the inter-packet gap of the packet stream to facilitate the photonic switch being completely set up between the end of one packet and the start of the next packet.

Buffer 148 stores the packet while the packet address and length are read. Buffer 148 may include an array of buffers, so that packets with different destination addresses (i.e. different packet flows) may be buffered until the appropriate switching fabric output port has available capacity without delaying packets in other packet flows with other destination addresses where output port capacity is available sooner. Also, packet address and length characteristics are fed to read packet address and length characteristics module 142 and to switch control processor and connection request handler 154. The output of switch control processor and connection request handler 154 is fed to switch 150, which operates based on whether the packet length exceeds or does not exceed the packet size threshold value set by controller 130. Additionally, the packet is conveyed to switch 150, which is set by the output from switch control processor and connection request handler 154, so the packet will be routed to photonic switching fabric 112 or electrical packet switching fabric 116. For example, the routing is based on the determination by switch control processor and connection request handler 154 from whether the length of the packet exceeds a set packet length or another threshold. If the packet is routed to photonic switching fabric 112, it is passed to buffer and delay 152, and then to photonic switching fabric 112. Buffer and delay 152 stores the packet until the appropriate destination port of photonic switching fabric 112 becomes available, to avoid photonic buffering or storage by buffering in the electrical domain. Buffer and delay 152 may include an array of buffers, so that other packet streams not requiring buffering may be sent to the core switch.

On the other hand, if the packet is routed to electrical packet switching fabric 116, it is passed to buffer 156, statistical multiplexer 158, and statistical demultiplexer 160 to provide a relatively high port fill into the short packet fabric from the sparsely populated short packet streams at the exit from buffer 156. Then, the packets proceed to electrical short packet switching fabric 116 for routing to the destination combiners. Buffer 156, which may contain an array of buffers, stores the packets until they are sent to electrical packet switching fabric 116. Packets from multiple packet streams may be statistically multiplexed by statistical multiplexer 158, so the ports of electrical packet switching fabric 116 are better utilized. Statistical multiplexing may be performed to concentrate the short packet streams to a reasonable occupancy, so existing electrical packet switch ports are suitably filled with packets. For example, if the split in packet lengths is set up for an 8:1 ratio in bandwidths for the photonic switching fabric and the electrical packet switching fabric, the links to the electrical packet switching fabric may use 8:1 statistical multiplexing to achieve relatively filled links. This statistical multiplexing introduces additional delay, dependent on the level of statistical multiplexing used in the short packet path, which may trigger incorrect long/short packet sequencing during the combining process when excessive statistical multiplexing is applied. To prevent this, precautions may be taken, for example the use of a sequence number. Then, statistical demultiplexer 160 performs statistical demultiplexing for low occupancy data streams into a series of parallel data buffers. The level of statistical multiplexing applied across statistical multiplexer 158 and statistical demultiplexer 160 may be controlled so the delay is not excessive. In the case of a long/short packet split where 12% of the packet bandwidth is short packets, statistical multiplexing should not exceed ˜7-8:1. However, when 5% of the packet bandwidth is short packets (as determined by setting the long/short threshold value) the statistical multiplexing may approach ˜15-20:1.

Photonic switching fabric 112 contains a control unit. Photonic switching fabric 112 may be a multistage solid state photonic switching fabric created from a series of several stages of solid state photonic switches. In an example, photonic switching fabric 112 is a 1 ns to 5 ns photonic fast circuit switch suitable for use as a synchronous long packet switch implemented as a 3 stage, or a 5 stage CLOS fabric fabricated from N×N and M×2M monolithic integrated photonic crosspoint chips, for example in silicon, indium phosphide or another material, where N is an integer which may range from about 8 to about 32 and, M is an integer which may range from about 8 to about 16.

Electrical short packet switching fabric 116 may receive packets using statistical multiplexer 160 and statistically demultiplex already switched packets using statistical demultiplexer 164. The packets are then further demultiplexed into individual streams of short packets by statistical demultiplexer 174 in combiner 120 to produce a number of sparsely populated short packet streams into buffers 170 for combination with their respective long packet components within combiner 120. Electrical packet switching fabric 116 may include processing functions responsive to the packet routing information for an electrical packet switch and buffer 162, which may include arrays of buffers. Electrical packet switching fabric 116 may be able to handle the packet processing associated with handling only the short packets, which may place some additional constraints and demands on the processing functions. Because the bandwidth flowing through photonic switching fabric 112 is greater than the bandwidth flowing through electrical packet switching fabric 116, the number of links to and from photonic switching fabric 112 may be greater than the number of links to and from electrical packet switching fabric 116. Alternatively, the links to the photonic switch may be of greater bandwidth (e.g. 100 Gb/s) than the short packet streams (e.g. 10 Gb/s).

The switched packets from photonic switching fabric 112 and electrical packet switching fabric 116 are fed to combiner 120, which combines the two switched packet streams by interleaving the packets in sequence based on a flow-based sequence number applied to the individual packets of the packet stream before being split in the packet splitter. Combiner 120 contains packet granular combiner and sequencer 166. The photonic packet stream is fed to buffer 172 to be stored, while the address and sequence is read by packet address and sequence reader 168, which determines the source and destination address and sequence number of the photonic packet. The electrical packet stream is also fed to statistical demultiplexer 174 to be statistically demultiplexed and to buffer 176 to be stored, while its characteristics are determined by the packet address and sequence reader 168. Then, packet address and sequence reader 168 determines the sequence to read packets from buffer 172 and buffer 176 based on interleaving packets from both paths to restore a sequential sequence numbering of the packets in each packet flow, so the packets of the two streams are read out in the correct sequence. Next, the packet sequencing control unit 170 releases the packets in each flow in their original sequence. As the packets are released by packet sequence control unit 170, they are combined by a process of packet interleaving based on their sequence number using switch 178. Splitter 106 may be implemented in TOR switch 104, and combiner 120 may be implemented in TOR switch 128. TOR switch 128 may be housed in rack 126. Also, packet granular combiner and sequencer 166 may optionally contain decelerator 167, which decelerates the packet stream in time, decreasing the inter-packet gap. For example, decelerator 167 may reduce the inter-packet gap to the original inter-packet gap before accelerator 147. Acceleration and deceleration are further discusses in U.S. patent application Ser. No. 13/901,944 filed on May 24, 2013, and entitled “System and Method for Accelerating and Decelerating Packets,” which application is hereby incorporated herein by reference.

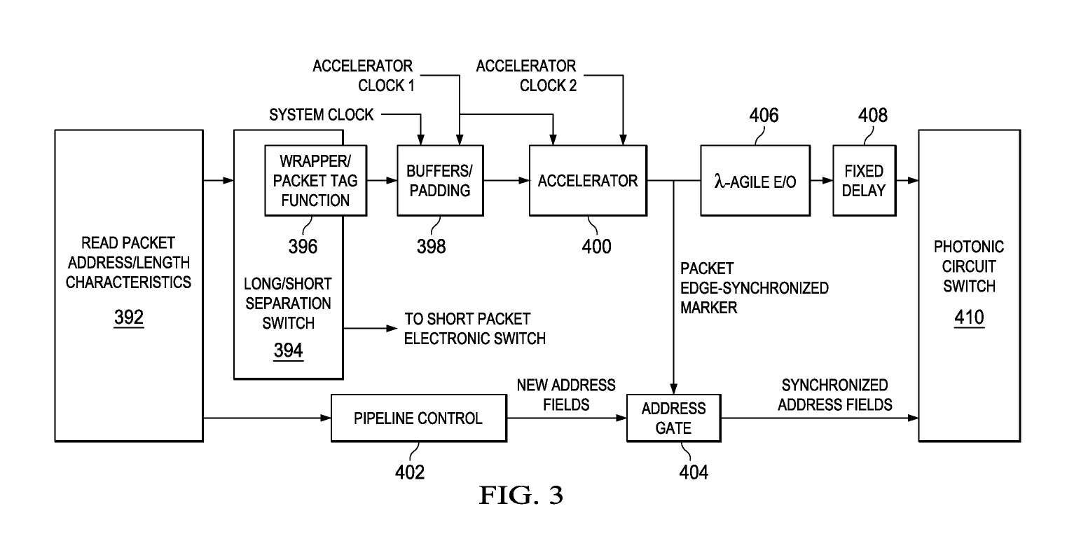

FIG. 3 illustrates the flows for the long packets through the buffer/padding and acceleration functions while the address routing and switch cross connections are processed and derived in a parallel process through a pipelined control system. The buffer and padding produce a packet stream where the packets are the same length by padding them by adding extra bytes which will be later removed, which makes the packets last the same length of time, facilitating synchronous switching.

In block 392, the packet address and length characteristics are read. These characteristics are passed to long/short separation switch 394 and pipelined control block 402.

In pipelined control block 402, pipelined control processing causes a short delay which depends on the structure of this block and its implementation, but may be in the range of a few microseconds. The delay may be longer than the fixed frame time of each containerized packet, which is conducive to the pipelined approach, where one stage of the pipeline is completing the connection map computations for a specific frame, while another earlier stage of the pipeline is completing an earlier part of the computations for the next frame, all the way back to the first stage of the pipeline which is completing the first computation for the m^{th} frame, where m is the number of pipeline segments in series through the pipeline process. The packet addressing information from block 392 is input into and processed by pipelined control block 402. A continuous flow of packet address fields in the pipeline produces a switch connection map for each frame. Pipelined control block 402 is configured to deliver new address maps for the entire switch once per packet interval or frame. In one example, the delay is for m steps, where a step is equal to or less than one packet duration, so each stage is cleared to be ready for the next frame's computation. In another example, some steps exceed a frame length, and two or more of the functions are connected in parallel and commutated. The overall delay is fixed by the summation of times for the multiple steps of the control process. A new address field is produced during the containerized packet intervals (frame period). The continuous flow of computed control fields may be accomplished by breaking down the complete set of processes to complete the connection map calculations into individual serial steps which are completed in a packet interval. If a series of m serial steps is defined, where the steps can be completed within a packet interval before handing off the results to the next step, the complete address map are delivered every packet interval, but delayed by m packets. Hence, there is a delay generated by the control path while the “m” steps are completed.

Long/short separation switch 394 separates the short packets from the long packets. In one example, short packets are shorter than a threshold, and long packets are longer than or equal to the threshold. Short packets are passed to a short packet electronic switch or dealt with in another manner, while long packets go to wrapper 396.

Wrapper 396 provides a wrapper or packet tag for the packet. This creates a wrapped container including the source and destination TOR addresses for the container payload and the container (packet) sequence number, while the container payload contains the entire long packet including the header. Most long packets are at, or close to, the maximum size level (e.g. 1,500 bytes), but some long packets are just above the long/short threshold (e.g. 1,000 bytes), and are mapped into a 1,500 byte payload container by filling the rest of the container with padding.

Buffer 398 provides padding to the packet to map the packet into the payload space and complete the filling of the payload space with padding. Buffer 398 produces a packet stream where the packets have the same length by padding them out by adding extra bytes, which will be removed after the switching process. Because padding involves adding extra bytes to the data stream, there is an acceleration of the packet stream. Buffer 398 has a higher output clock speed than the input clock speed. This higher output clock speed is the input clock speed of accelerator 400. The clock rate increase in buffer 398 depends on the length of the buffer, the packet length threshold, and the probability of a buffer overflow. The padding buffer introduces a delay, for example from around 2 to around 12 microseconds for 40 Gb/s feeds. The clock rate increase is less for long buffers and longer delays, so there is a trade-off between clock rate acceleration and delay. The clock rate increase is less for the same delay for higher rate feeds—e.g. 100 Gb/s, because the buffer may include more stages.

Then, accelerator 400 accelerates the packets to increase the inter-packet gap to provide a timing window for setting up of the photonic cross-point between the trailing edge of one packet and the leading edge of the next packet.

Long/short separation switch 394, wrapper 396, and buffer 398 have a delay from padding and accelerating the packets. This delay varies with the traffic level and packet length switch, and may be padded out to approximately match the delay through the control path, for example by inserting extra blank frames in the buffer/padding process. Buffer 398 and accelerator 400 may be implemented together or separately.

Electro-to-optical (E/O) converter 406 converts the packets from the electrical domain to the optical domain.

After being converted to the optical domain, the packets experience a delay in block 408. This delay is a fixed delay, for example about 5 ns, to facilitate the addresses being set up before the start of the packet arrives. When the delays of the two paths are balanced, the addresses arrive at photonic circuit switch 410 at the same time as the packet arrives at photonic circuit switch 410. When the address computation path occurs a little quicker than the shortest delay through the buffer and acceleration path, a marker, tag, or wrapper indicator may trigger the synchronized release of the address information to the switch from a computed address gating function.

Address gate 404 handles the addresses from pipelined control block 402. New address fields are received every frame interval from pipelined control block 402. Also, packet edge synchronization markers are received from accelerator 400. Address gate 404 holds the process address fields for application to the switch, and releases packets on the edge synchronization marker, and may store multiple fields to be released in sequence. Address gate 404 releases synchronization address fields each packet interval.

Finally, the optical packets are switched by photonic circuit switch 410.

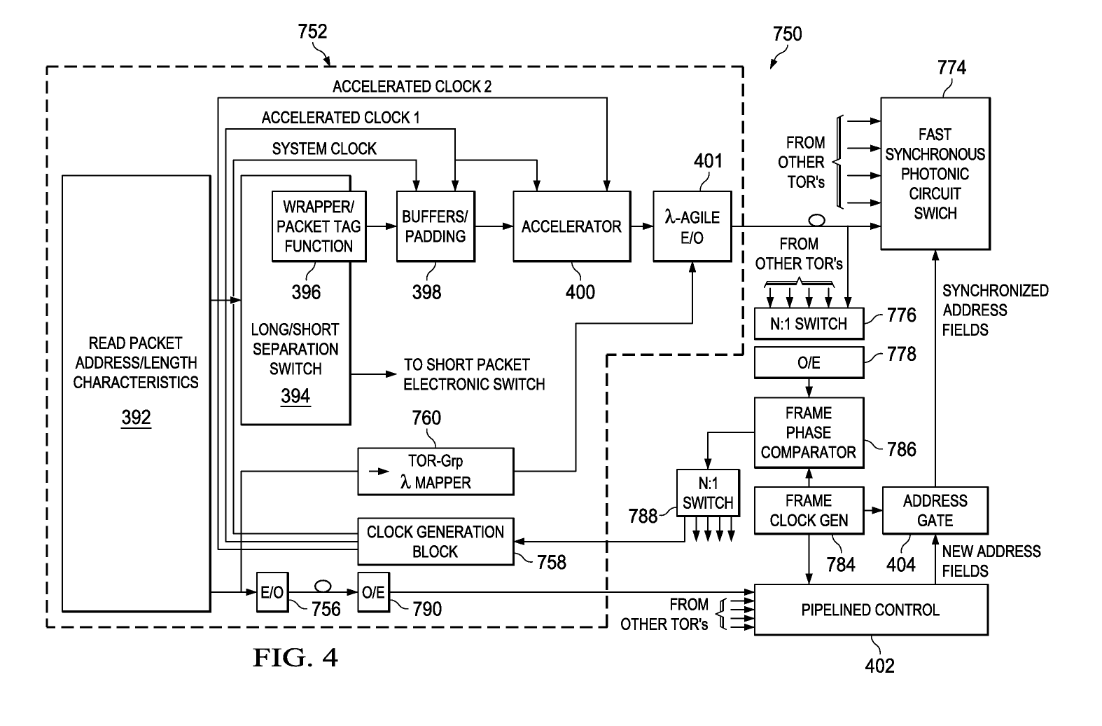

In a large data center the TORs and their associated splitter and combiner functions may be distant from the photonic switch, which is illustrated by system 750 in FIG. 4. System 750 contains block 752, the functionality of which may be co-located, for example at each TOR or small group of TORs. In block 392, the incoming packets are examined to ascertain their lengths and the packet addresses, which are translated into TOR and TOR group addresses. This may be done by the host TOR, or it may be done locally within block 392. For long packets, the translated addresses are added to the next available address frame slot.

This address frame is sent via an electro-optical link to pipelined control block 402, which may be co-located with photonic switching fabric 774. The frame is converted from the electrical domain to the optical domain by electrical-to-optical converter 756. The frame propagates an optical fiber with a delay, and is converted back to the electrical domain by optical-to-electrical converter 790.

Also, block 392 determines the packet length, which is compared to a length threshold. When the packet length is below the threshold, the packet is routed to the short packet electronic switch (along with a packet sequence number, and optionally the TOR and TOR group address) by long/short separation switch 394. When the packet is at or above the threshold value, it is routed to wrapper 396, where it is mapped into an overall fixed length container, and padded out to the full payload length when the packet is not already full-length. A wrapper header or trailer is added, which contains the TOR/TOR group source and destination address and the packet sequence number for restoring the packet sequencing integrity at the combiner when the short and long packets come back together after switching. For example, the source TOR group address, individual source TOR address within the source TOR group, destination TOR group address, and individual destination TOR address within the destination TOR group are included in the packet.

The wrapped padded packet container then undergoes two steps of acceleration. First, the bit-level clock is accelerated from the system clock to accelerated clock 1 by buffer 398 to facilitate sufficient capacity when short streams of long but not maximum length containerized packets pass through the system. For a maximum length packet, for example a 1500 byte packet at 100 Gb/s, the packet arrival rate is 8.333 megapackets per second, generating a frame rate of 120 ns/containerized packet. However, packets longer than the long/short packet threshold may be shorter than the full length, for example 1 000 bytes. Such shorter long packets, when contiguous, may have a higher frame rate, because they can occur at a higher rate. For 1000 byte packets arriving at 100 Gb/s, the packet arrival rate is up to 12.5 megapackets/sec, generating an instantaneous frame rate of 80 ns/containerized packet. With a continuous stream of shorter long packets, the frame rate may be increased up to 80 ns per frame, an acceleration of about 50%. However, the occurrence of these packets is relatively rare, and a smaller acceleration somewhat above that to support their average occurrence rate, combined with a finite length packet buffer, may be used.

The accelerated packet stream is then passed to accelerator 400, which further accelerates the packet stream so the inter-packet gap or inter-container gap is increased, facilitating the photonic switch being set up between switching the tail end of one packet to its destination and switching the leading edge of the next packet to a different destination. More details on increasing an inter-packet gap is discussed in U.S. patent application Ser. No. 13/901,944 filed on May 24, 2013, and which application is hereby incorporated herein by reference.

Although shown separately, buffer 398 and accelerator 400 may be combined in a single stage.

The output from accelerator 400 is passed to electrical-to-optical converter 401 for conversion to a photonic signal to be switched. The photonic signal is sent to photonic switching fabric 774 across intra-datacenter fiber cabling, which may have a length of 300 meters or more, and hence a significant delay due to the speed of light in glass. This electrical-to-optical conversion may be a wavelength-agile electrical-to-optical converter.

From any input port on an input switch module, the application of a specific wavelength will reach ports on a specific output switch module and not another output switch module. Therefore, when the addressing of the TORs is divided into TOR groups, where each TOR has a TOR group number and an individual TOR number within that group, and each group is associated with a specific third stage switch module, any TOR in a given input group may connect to the appropriate third stage for the correct destination TOR group of the destination TOR by utilizing the appropriate wavelength value in the electrical-to-optical conversion process. Hence, the TOR group portion of the address is translated in TOR group to wavelength mapper block 760 into a wavelength to drive electrical-to-optical converter 401.

Because the TORs and their associated splitter/combiner may be remote from the photonic switch, there may be a distance dependent delay between the splitter output and the optical signal arriving at the switch input for different splitters and their associated TORs. Because the signals are accurately aligned in time due to closed loop timing control, such as that shown in FIG. 4, the end of one packet from one splitter properly aligns with the start of the next packet in the switch, even when it is from another splitter. Thus, the delay may be calibrated and compensated for. One method is to tap the input signal at the photonic switch input and feed the tapped component to optical-to-electrical receiver 778. The timing of the start of the incoming containers is determined relative to frame generation timing block 784 by frame phase comparator 786. The difference in timing generates an error signal indicating whether the incoming container is early or late and the magnitude of the error. This error signal is fed back to clock generation block to adjust its phase so the containers are transmitted at the right time and arrive at the photonic switch inputs with the correct timing.

This may be done across the inputs of the photonic switch and for the subtending TOR based splitters, which uses many optical-to-electrical converters. To reduce the number of optical-to-electrical converters, switch 776, an N:1 photonic selector switch between the tapped outputs and optical-to-electrical converter 778 is used, reducing the number of optical-to-electrical converters by N:1, for example, 8:1 to 32:1, and uses a sample and hold based approach to the resultant phase locked loop. Likewise, switch 788, an N:1 switch is inserted between frame phase comparator 786 and clock generation block 758.

This leads to satisfactory performance when clock generation block 758 does not drift significantly during the hold period between successive feedback samples. When a 1 ms thermo-optic switch is used, about 800 corrections per second may be made. If the switch is a 32:1 switch, each TOR splitter timing phase locked loop (PLL) is corrected 25 times a second, or once every 40 ms. Hence, to maintain 1 ns precision timing, a basic precision and stability of about 1 in 4×10⁷ may be used. With an electro-optic switch with a 100 ns response time, the overall correction rate increases to about 2,500,000-4,800,000 times a second, for 40 Gb/s to 100 Gb/s data rates. When the switch is 32:1, there may be 80,000-150,000 measurements/sec per TOR splitter PLL, which yields an accuracy and stability of 1 part in 1.25×10⁴ to 1 part in 6.7×10³ for 40 and 100 Gb/s operation respectively.

The delay through the connection signaling—signaling optical propagation—connection processing path plus the physical layer set up time may be less than the delay through the padding buffers, accelerators, and container optical propagation times. The delay from read packet address block 392 to accelerator 400 (Delay 1), which is largely caused by the length of buffer 398 and accelerator 400, varies with the traffic level and packet length mix. The delay in pipelined control block 402 (Delay 2) from the m-step pipelined control process is fixed by the control process. The delays over the fibers (Delay 3 and Delay 4), which may be the same fiber, may be approximately the same. The optical paths may use coarse 1300 nm or 1550 nm wavelength multiplexing. It is desirable for Delay 2+Delay 3<Delay 1+Delay 4. When Delay 3=Delay 4, Delay 2 is less than Delay 1. This facilitates that the switch connection map being computed and applied before the traffic to be switched is applied. The tolerances or variations in the two paths affects the size of the inter-packet gap, because it acts as timing skew in addition to the switch set up time itself.

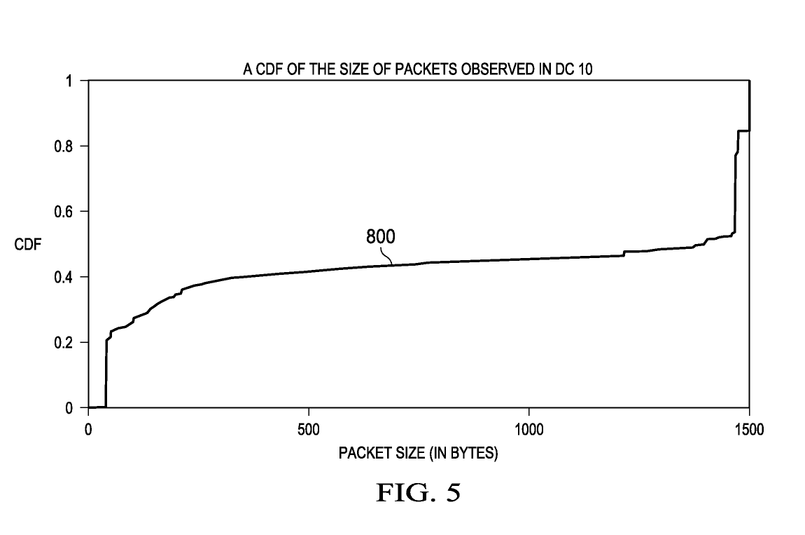

FIG. 5 illustrates cumulative distribution function (CDF) 800 for the probability distribution of packet sizes. This graph shows the cumulative distribution function of the number of packets in a stream as a function of packet size, in bytes.

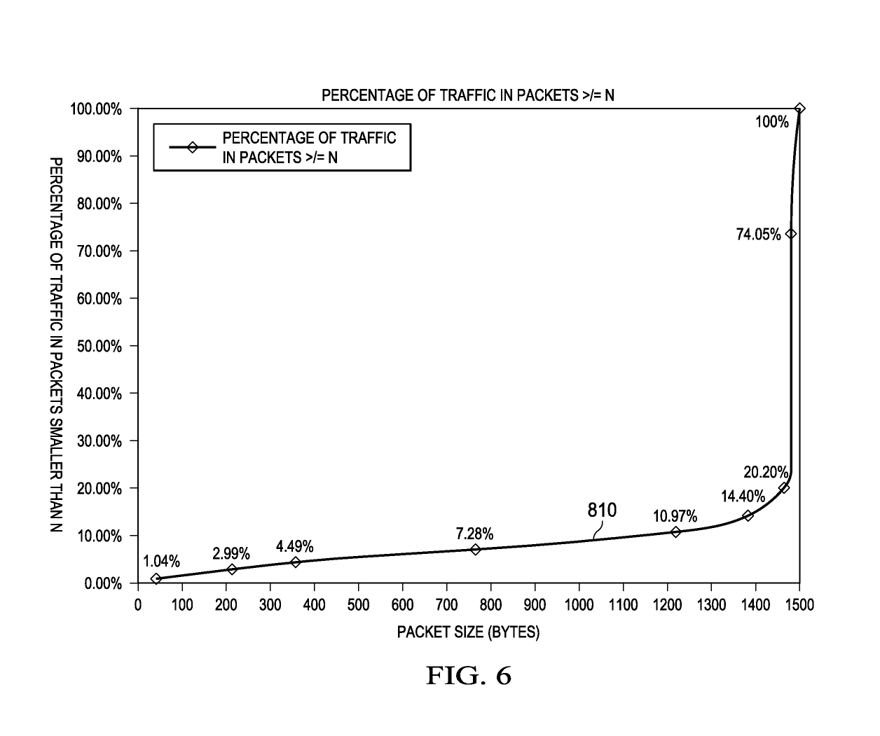

When the packet bandwidth per size of packet, for example at one packet of that size every second, is multiplied with the CDF of the packet occurrence rate shown in FIG. 5, a cumulative distribution function whereby the CDF of the fractional bandwidth of the data link as a function of packet size is illustrated. This process is applied to the distribution of FIG. 5 and produces a new CDF plot, shown in FIG. 6. FIG. 6 shows curve 802 illustrating the percentage of traffic bandwidth in packets smaller than a given packet size as a function of the packet size in bytes. Approximately 80% of the bandwidth is in packets of 1460 bytes or more, while 20% of the bandwidth is in packets less than 1460 bytes. Approximately 90% of the bandwidth is in packets of 1160 bytes or more, while 10% is in packets less than 1160 bytes, and 95% of traffic bandwidth is in packets of 500 bytes or more, while only 5% is in packets less than 500 bytes. If a long/short threshold is set, for example 500 bytes, of the 95% of the bandwidth that is in long packets, 80% is in packets that are within 40 bytes of maximum, and 15% of the overall bandwidth is in packets between 500 bytes and 1460 bytes. For a 1000 byte threshold, about 9% of bandwidth capacity is in short packets (i.e. below the long/short threshold), and 91% of bandwidth is in long packets at or above the threshold, of which 80% of overall bandwidth is in packets that are within 40 bytes of maximum, and 11% is in packets between 1000 and 1460 bytes. The use of a 500 byte threshold corresponds to a long/short capacity split of 19:1, for an overall node capacity 20 times the size of the short packet electronic switch, while the use of a 1000 byte threshold corresponds to a long/short capacity split of 10:1, for an overall node capacity gain of 11 times the capacity of the short packet switch.

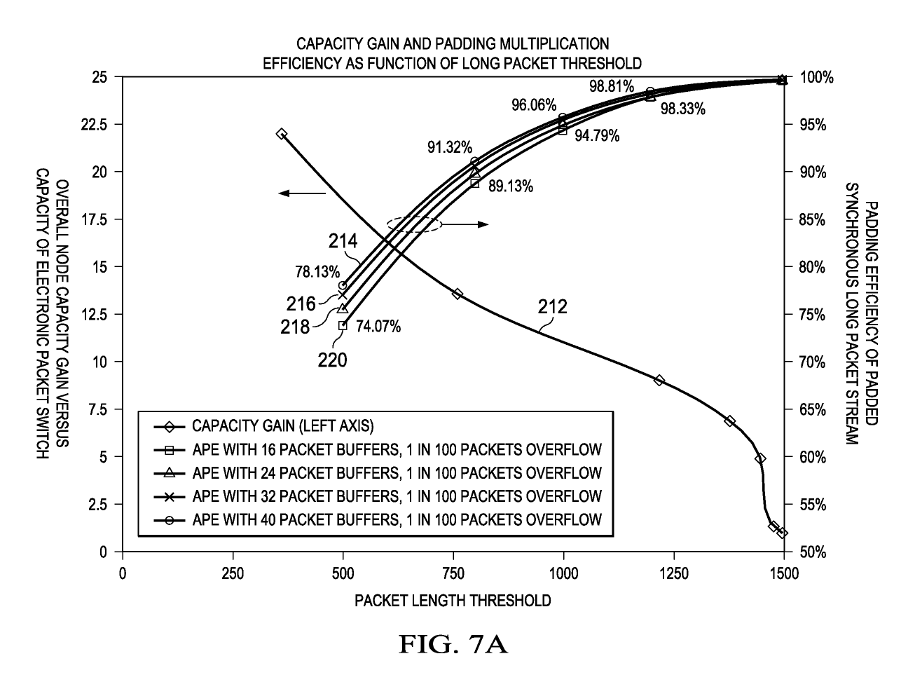

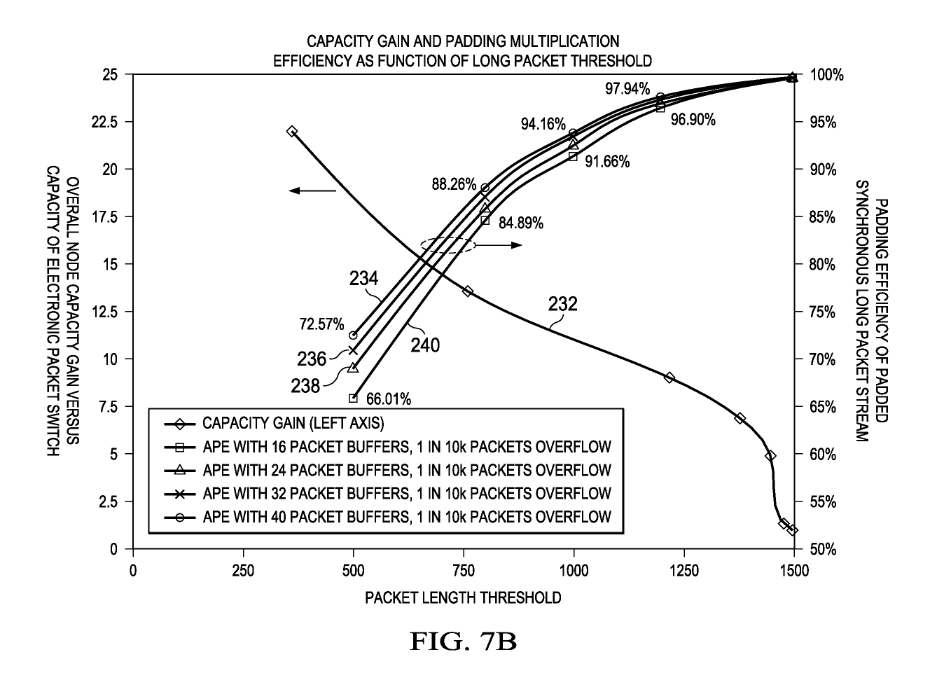

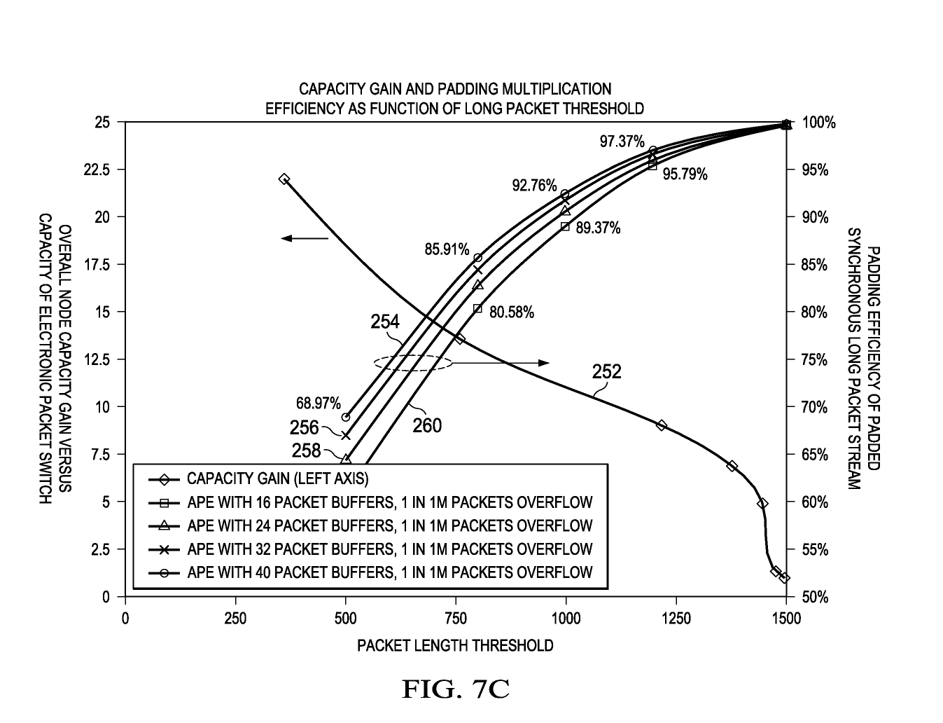

However, long packets do exhibit a size range, leading to for the desirability of buffering and acceleration. FIGS. 7A-C show a modeled capacity gain for an embodiment photonic packet switch over the capacity of an electronic packet switching node as a function of the packet size threshold and the padding efficiency, which indicates the amount of excess bandwidth used on the photonic path from the mix of packet lengths in the long packet stream for the traffic having the characteristics illustrated in FIG. 5.

FIG. 7A shows the simulation results for the padding of various lengths of long packets out to a 1500 byte maximum payload and the resultant acceleration plotting these against threshold value, using the traffic model of FIG. 6. These results show the overall node capacity gain and synchronous circuit switching packet padding efficiency versus packet length threshold for a relatively high 1% probability of buffer overflow. Curve 212 shows the capacity gain as a function of long packet length threshold. Curve 214 shows the padding efficiency with 40 packet buffers, curve 216 shows the padding efficiency with 32 packet buffers, curve 218 shows the padding efficiency with 24 packet buffers, and curve 220 shows the padding efficiency with 16 packet buffers. A packet length threshold around 1000 bytes yields a capacity gain of about 11:1, representing more than an order of magnitude capacity increase, at which point the padding efficiency is around 95%.

Packets at the lower end of the long packet size range are padded out to the same length as the longest packets. These shorter packets can arrive more frequently than the long packets, because, at the basic clock rate, they occupy a shorter period in time. For example, at a 40 Gb/s rate, a 1500 byte packet occupies 300 ns, but a 1000 byte packet occupies only 200 ns. If the switch is set for a 300 ns frame rate, consecutive 1000 byte packets arrive at a rate 50% faster than the switch can handle. To compensate for this, the frame rate of the switch is accelerated. If a padding buffer is not used, acceleration may be substantial. Table 1 below shows the acceleration without a padding buffer, as a function of threshold length. There are significant inefficiencies for packet length thresholds below around 1200 bytes.

TABLE 1

| Threshold | Aggregate Padding | Accelerated |
|---|---|---|
| (Bytes) | Efficiency (%) | Clock Rate |
| 1500 | 100 | 1:1 |
| 1200 | 80 | 1.25:1 |
| 1000 | 66.7 | 1.5:1 |
| 800 | 53.5 | 1.87:1 |
| 500 | 33.3 | 3:1 |

A padding buffer is a packet synchronized buffer of a given length in which packets are clocked in at a system clock rate and are extended to a constant maximum length, and are clocked out at a higher clock rate. Instead of choosing an accelerated clock rate to suit the shortest packets, a clock rate can be chosen based on traffic statistics and the probability of traffic with those statistics overflowing the finite length buffer.

Table 2 below shows the results with and without a padding buffer for a 1% probability of packet overflow. There is a substantial improvement in clock acceleration when using a padding buffer over no padding for short buffers. The relationship between aggregate padding efficiency (APE) and required clock rate is a reciprocal relationship with the clock rate increasing 3:1 at a 33% APE, down to a clock rate increase of 1.2% at 98.8% APE. Hence, a higher APE leads to a lower clock rate increase and a smaller increase in the optical signal bandwidth.

TABLE 2

| Packet Length Threshold | 500 | 800 | 1000 | 1200 |
|---|---|---|---|---|
| APE no padding | 33% | 53.3% | 66.7% | 80% |
| APE 16 byte padding | 74.1% | 89.1% | 94.8% | 98.3% |
| APE 40 byte padding | 78.1% | 91.3% | 96.1% | 98.8% |

FIG. 7B shows the overall node capacity gain and synchronous circuit switching packet padding efficiency versus packet length threshold for a 0.01% probability of buffer overflow. Curve 232 shows the capacity gain as a function of the packet length threshold. Curve 234 shows the padding efficiency with 40 packet buffers, curve 236 shows the padding efficiency with 32 packet buffers, curve 238 shows the padding efficiency with 24 packet buffers, and curve 240 shows the padding efficiency with 16 packet buffers. Longer buffers better improve APE at the expense of delay. Hence, there is a trade-off between the delay and the APE, and hence clock rate acceleration. In one example, this delay is set to just below the processing delay of the centralized processing block, resulting in that block setting the overall processing delay.

Table 3 shows the padded clock rates as a percentage of base system clock rates and as APEs with a 0.01% probability of buffer overflow for various packet length thresholds. The rates for 24 and 32 packet buffers are between the results for 16 packet buffers and for 40 packet buffers. The clock rate escalation can be reduced by using relatively short finite length buffers. The longer the buffer, the greater the improvement.

TABLE 3

| Packet Length Threshold | 500 | 800 | 1000 | 1200 |
|---|---|---|---|---|
| APE no padding | 33% | 53.3% | 66.7% | 80% |
| Clock no padding | 300% | 187.5% | 150% | 125% |
| APE 16 packet padding | 66.0% | 84.9% | 91.7% | 96.9% |
| Clock 16 packet padding | 151.5% | 117.8% | 109.1% | 103.2% |
| APE 40 packet padding | 72.6% | 88.2% | 94.2% | 97.9% |
| Clock 40 packet padding | 137.8% | 113.3% | 106.2% | 102.1% |

FIG. 7C shows the overall node capacity gain and synchronous circuit switching packet padding efficiency versus packet length threshold for a one in 1,000,000 probability of buffer overflow. Curve 252 shows the capacity gain as a function of the packet length threshold. Curve 254 shows the padding efficiency with 40 packet buffers, curve 256 shows the padding efficiency with 32 packet buffers, curve 258 shows the padding efficiency with 24 packet buffers, and curve 260 shows the padding efficiency with 16 packet buffers.

For a capacity gain of 10:1, where the aggregate node throughput is ten times the throughput of the electronic short packet switch, the packet length threshold is around 1125 bytes. This corresponds to an APE of around 75% with no padding buffer, and a padded clock rate of 133% the input clock rate, a substantial increase. With a 16 packet or 40 packet buffer, this is improved to an APE of 95% and 97%, resulting in padded clock rates of 105.2% and 103.1% of the input clock. This is a relatively small increase.

In a synchronous fast photonic circuit switch, a complete connection reconfiguration at a repetition rate matching the padded containerized packet duration is performed. For 1500 byte packets and a 40 Gb/s per port rate, this frame time is about 300 ns. Hence, a very fast computation of the connection map is used in a common (centralized) control approach to deliver a new connection map every frame period (300 ns for the 40 Gb/s). In a common fabric approach, the switch may be non-blocking across the fabric with only output port contention blocking when two inputs simultaneously attempt to access the same switch output port. This blocking may be detected using the connection map generation, because, when two inputs request the same output, one input may be granted a connection and the other input delayed a frame or denied a connection. When a frame is denied a connection, the TOR splitter may re-try for a later connection or the packet is discarded and re-sent.

A large fast photonic circuit switch fabric may contain multiple stages of switching. These switches provide overall optical connectivity between the fabric input ports and output ports in a non-blocking manner where new paths are set up without impacting existing paths or in a conditionally non-blocking manner where new paths are set up which may involve rearranging existing identified paths. Whether a switching fabric is non-blocking or conditionally non-blocking depends on the amount of dilation. In a dilated switch with 1:2 dilation, the second stages combined have twice the capacity of all the first stage input ports. A switching fabric may be composed of multiple combinations of these building blocks.

Two building blocks that may be used in a photonic switch are photonic crosspoint arrays and array waveguide routers (AWG-Rs). Photonic crosspoint arrays may be thermo-optic or electro-optic. AWG-Rs are passive, wavelength sensitive routing devices which may be combined with agile, optically tunable sources to create a switching or routing function.

In one example, an integrated photonic switch is fabricated in InGaAsP/InP semiconductor multilayers on an InP substrate. The switches have two passive waveguides crossing at a right angle forming input and output ports. Two active vertical couplers (AVC) are stacked on top of the passive waveguide with a total internal mirror structure between them to turn the light through the ninety degree angle. There may be a loss of around 2.5 dB for a 4×4 switch. The switching time may be about 1.5 ns to about 2 ns. An operating range may be from 1531 nm to 1560 nm. A 16×16 port switch may have a loss of about 7 dB.

A rectangular switch with a different aspect ratio may be fabricated for a dilated switch. 16×8 or 8×16 port switches may have losses of around 5.5 dB and use 128 AVCs.

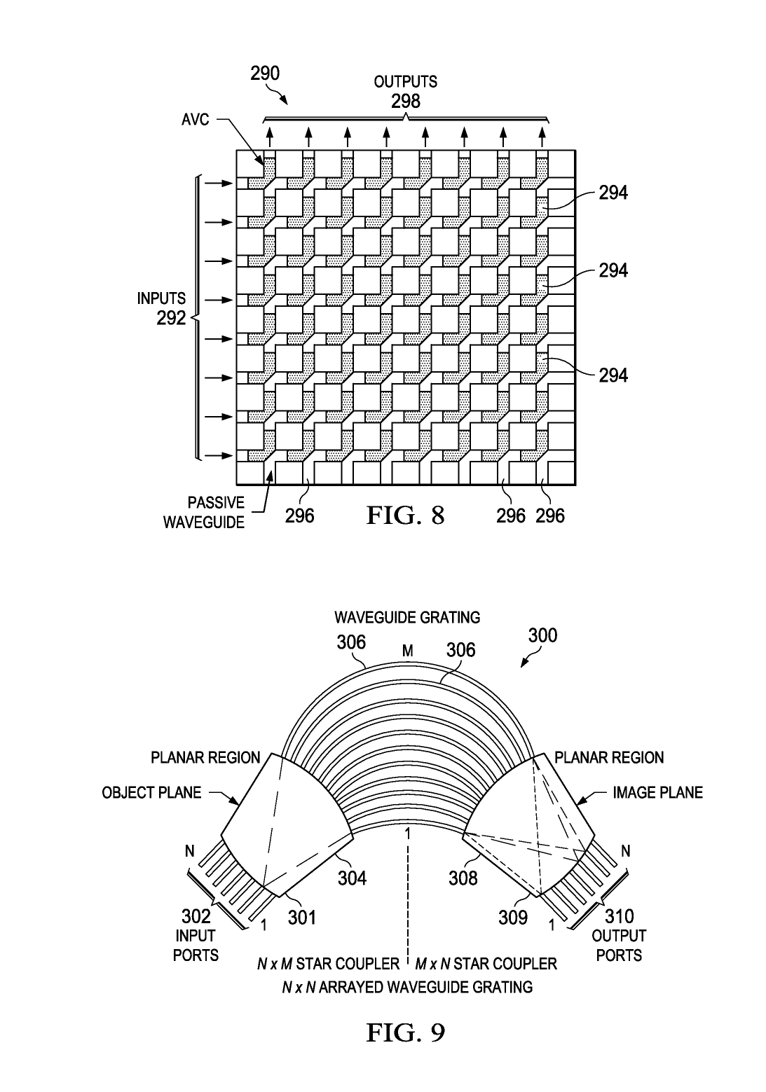

FIG. 8 illustrates switch 290, a solid state photonic switch, for the case of N=8. Switch 290 may be used for fabrics in first stage fabrics, second stage fabrics, and/or third stage fabrics. Switch 290 may be a non-blocking indium phosphide or silicon solid state monolithic or hybridized switch crosspoint array. Switch 290 contains inputs 292 and outputs 298. As pictured, switch 290 contains eight inputs 292 and eight outputs 298, although it may contain more or fewer inputs and outputs. Also, switch 290 contains AVCs 294 and passive waveguides 296. AVCs are pairs of semiconductor optical amplifier parts fabricated on top of the waveguide with an interposed 90 degrees totally internally reflective waveguide corner between them. These amplifiers have no applied electrical power when they are off. Because the AVCs are off, they are opaque, and the input optical waveguide signal does not couple into them. Instead, the optical signal propagates horizontally across the switch chip in the input waveguide. At the crosspoint where the required output connection crosses the input waveguide the AVC is biased and becomes transparent. In fact, the AVC may have a positive gain to offset the switching loss. Because the AVC is transparent, the input light couples into it, then turns the corner due to total internal reflection, and couples out of the AVC into the vertical output waveguide.

In another example, an electro-optic silicon photonic integrated circuit technology is used for a photonic switch, where the internal structure uses cascaded 2×2 switches in one of several (e.g. Batcher-Banyan, Benes, or another topology) topologies.

FIG. 9 illustrates AWG-R 300, a passive, wavelength-sensitive optical steering device which relies on differing path lengths to create different wave-fronts as a function of optical wavelength in an optical chamber so light converges at different outputs as a function of wavelength. The path length differences are established by the different waveguide lengths and the placement points. A W wavelength AWG-R has W inputs, W outputs, and uses W wavelengths. For input port 1, an input on wavelength 1 emerges for output port 1, an input on wavelength 2 emerges from port 2, etc., up to wavelength W, which emerges from output W. An input on input port 2 emerges shifted by one output port from that which the wavelength on input 1 would emerge. This shifting continues until, at input port W, wavelength W emerges from output port 1. Hence, wavelength 1 emerges from port 2, wavelength 2 emerges from port 3, and so forth, until wavelength W−1 emerges from port W, and wavelength W emerges from port 1. Light from the N input ports comes in through N input points 302 to planar region 304, which contains object plane 301. The light propagates along waveguide grating 306. Then the light proceeds along planar region 308, with image plane 309, to output ports 310.

Because the light entering the waveguides from planar region 304 has a different phase relationship/wave-front direction depending on which input port it originated from, the multiple components of the constituent input signals to planar region 308 interact to cancel or reinforce each other across the planar region 308 to create an output image of the input port at a position which depends on the position of the input port to planar region 304 and the wavelength, because the phase over different path lengths is a function of wavelength. The light is then coupled out of the device via output ports 310, based on which input it came from and its optical wavelength.

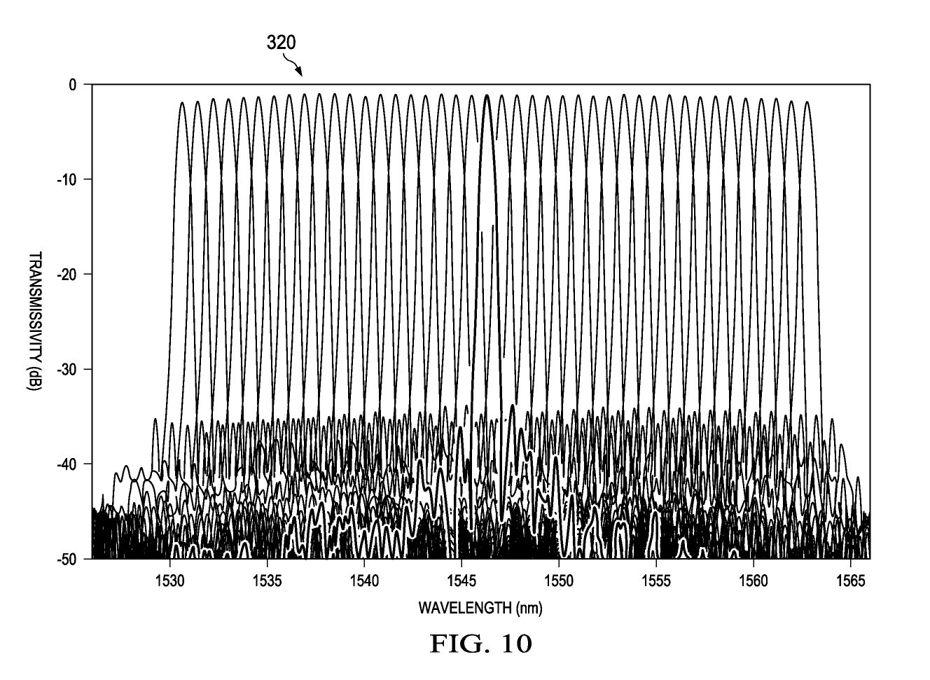

FIG. 10 illustrates transmission spectrum 320, an example transmission spectrum for an AWG-R. Transmission spectrum 320 is a transmission spectrum of a noncyclic 42 by 42 AWG-R. The channel spacing is 100 GHz and the Gaussian pass bands have a full-width half-maximum (FWHM) of 50 GHz.

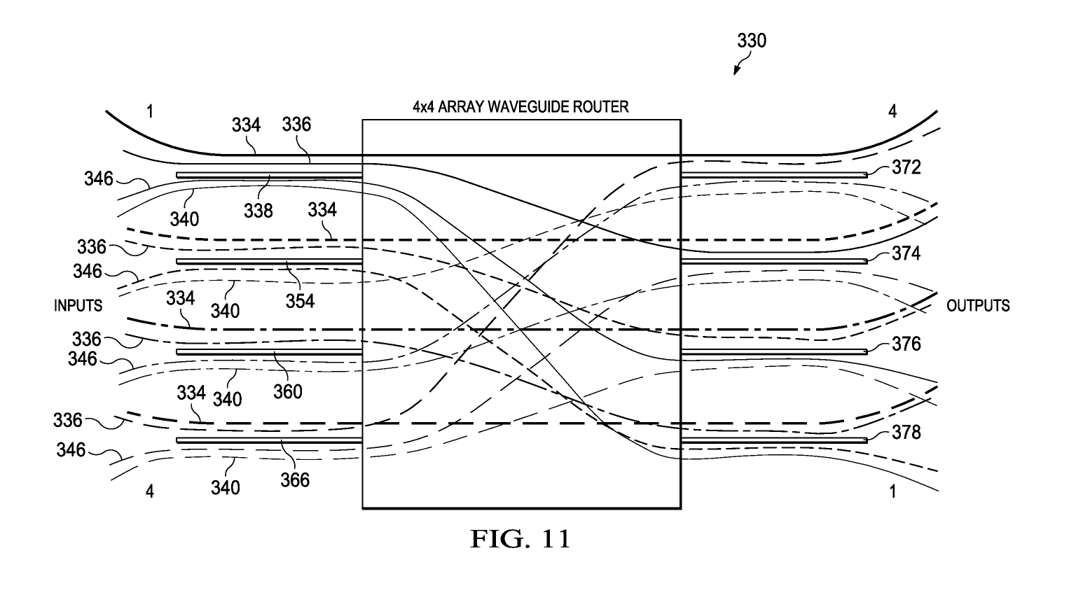

FIG. 11 illustrates a routing map of AWG-R 330 for a four by four AWG-R. To use AWG-R 330 as a switch, the wavelength of the incoming signal on a given input port is adjusted to change which output port it is routed to. AWG-R 330 contains input ports 338, 354, 360, and 366 and output ports 372, 374, 376, and 378. To connect input port 338 to output port 378, the input carrier 340 is received by input port 338. To connect input port 338 to output port 374, input carrier 336 is used. Likewise, to connect input port 366 to output port 376, input carrier 336 is used, and to connect input port 366 to output port 376, carrier 334 is used. Additionally, to connect input port 338 to output port 372, carrier 334 is used, and to connect input port 338 to output port 376, carrier 346 is used.

The AWG-R may be associated with a fast tunable optical source to change the wavelength in the inputs. These optical sources may be electronic-to-optical conversions points at the entry to the photonic domain if the range of optical wavelengths is supported through the intervening photonic components, such as crosspoint arrays, between the sources and the AWG-R. Fast tunable optical sources tend to be significantly slower than a few nanoseconds to tune, although they may be tuned in less than 100 nanoseconds. Thus, the tunable optical source should be tuned in advance. Hence, the required wavelength may be determined early in the pipelined control process.

In another example, a bank of optical carrier generators, for example continuously operating moderately high power lasers, at the wavelengths, produces an array of optical carriers which is optically amplified and distributed across the data center, with the TORs tapping off the selected optical wavelength or wavelengths via photonic selector switches driven by wavelength selection signals. This photonic selector switch may be a moderately fast L:1 switch, where L is the number of wavelengths in the system, in series with a fast on-off gate. In another example, the photonic selector is a fast L:1 switch. The selected optical carrier is then injected into a passive modulator to create a data stream at the selected wavelength to be sent to the photonic switch. These selector switches may be fabricated as electro-optic silicon photonic integrated circuits (PICs). In this example, an array of fast tunable precision lasers at the TORs is replaced with a centralized array of stable, precision wavelength sources which may be slow.

A CLOS switch configuration may be used in a photonic switching fabric. A CLOS switch has indirect addressing with interactions between paths. However, the fact that the buffer function puts multiple packets of delay into the transport/traffic path to the switch to contain the clock rate increases creates a delay on the transport path. This delay facilitates the application of a pipelined control system with no incremental time penalty when the pipelined control system can complete its calculations and produces a new connection map with less delay than its transport path. For example, the delay in the pipelined control is less than the delay in the wrapper, buffer, and accelerator.

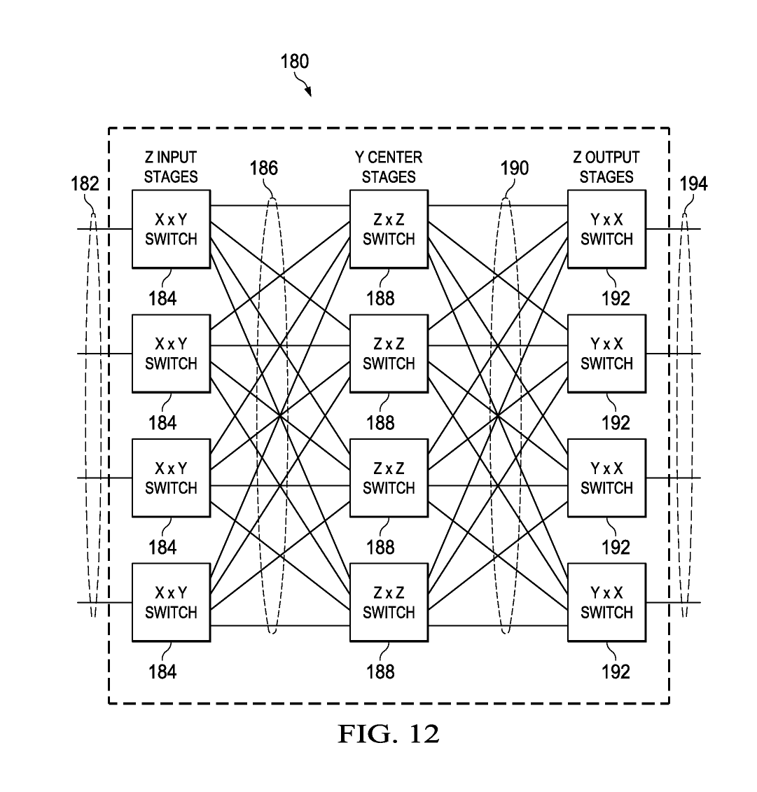

FIG. 12 illustrates an example three stage CLOS switch 180 fabricated from 16×16 fast photonic integrated circuit switch chips. A CLOS switch may have any odd number of stages, for example three. A CLOS switch may be fabricated with square cross-point arrays (cross-point arrays with the same number of inputs and outputs) where the overall central stage has the same number of available paths as the number inputs to the fabric. Such a switch is conditionally non-blocking, in that additional paths up to the port limits can always be added but some existing paths may be rearranged. Alternatively, the switch has excess capacity (or dilation) to reduce this effect by having rectangular first stages with more outputs than inputs. Also, the third stages are rectangular with the same number of inputs as first stage outputs. This dilation will improve the conditional non-blocking characteristics until just under 1:2 dilation X/(2X−1) when the switch becomes fully non-blocking meaning that a new path can always be added without disturbing existing paths. Because no existing paths need be disturbed there is no need for path rearrangement.

For example, CLOS switch 180 has a set up time from about 1 ns to about 5 ns. CLOS switch 180 contains inputs 182 which are fed to first stage fabrics 184, which are X by Y switches. Junctoring pattern of connections 186 connects first stage fabrics 184 and second stage fabrics 188, which are Z by Z switches. X, Y, and Z are positive integers. Also, junctoring pattern of connections 190 connect second stage fabrics 188 and third stage fabrics 192, which are Y by X switches, to connect every fabric in each stage equally to every fabric in the next stage of the switch. Making the switch dilating improves its blocking characteristics. Third stage fabrics 192 produce outputs 194 from input signals 182 which have traversed the three stages. Four first stage fabrics 184, second stage fabrics 188, and third stage fabrics 192 are pictured, but fewer or more stages (e.g. 5-stage CLOS) or fabrics per stage may be used. In an example, there are the same number of first stage fabrics 184 and third stage fabrics 192, with a different number of second stage fabrics 188, and Z is equal to Y times the number of first stages divided by the number of second stages. The effective input and output port count of CLOS switch 180 is equal to the number of first stage fabrics multiplied by X, for the input port count, by the number of third stage fabrics multiplied by X for the output port count. In an example, Y is equal to 2X−1, and CLOS switch 180 is at the non-blocking threshold. In another example, X is equal to Y, and CLOS switch 180 is conditionally non-blocking. In this example, existing circuits may be rearranged to clear some new paths. A non-blocking switch is a switch that connects N inputs to N outputs in any combination, irrespective of the traffic configuration on other inputs or outputs. A similar structure can be created with 5 stages for larger fabrics, with two first stages in series and two third stages in series.

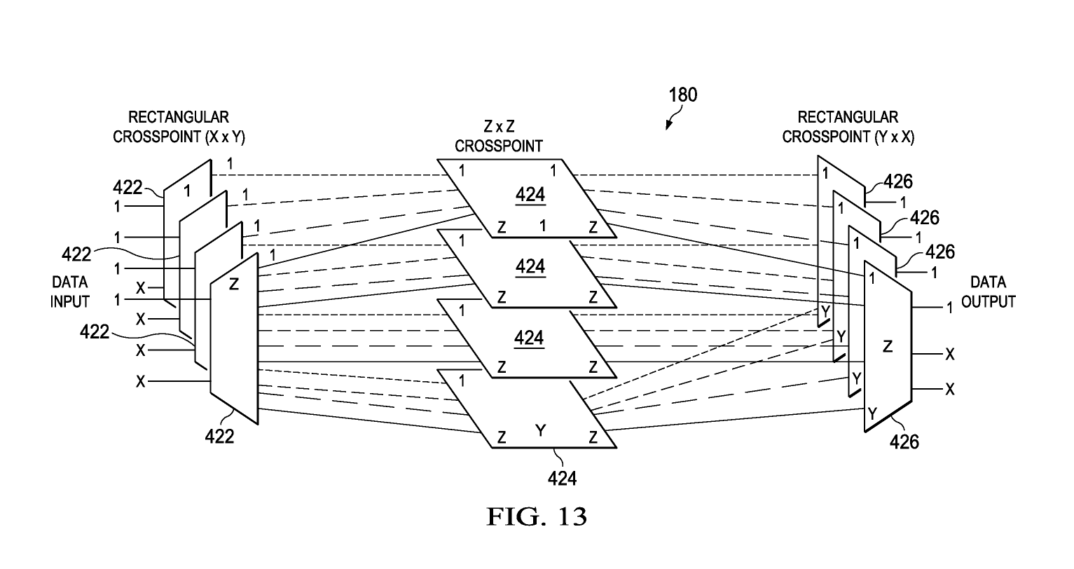

The same input port of each second stage module is connected to the same first stage matrix, and by symmetry across the switch, the same output port of each second stage module is connected to the same third stage module. The second stage modules are arranged orthogonally to the input and third stage modules. FIG. 13 illustrates the orthogonality of CLOS switch 180. CLOS switch 180 contains crosspoint switches 422, crosspoint switches 424, and crosspoint switches 426. All of the second stages connect to each first stage by the same second stage input and all the second stage outputs connect to each third stage via the same second stage output. This means that, irrespective of the settings of the first stage switch and the third stage switch, any connection between a given first stage and a given third stage uses the same connectivity through whichever second stage is selected. When the second stage is an AWG-R, this is determined by the wavelength of the source. As a result, if the addressing of the TORs is hierarchical, consisting of groups of TORs, where a group is associated with a first stage matrix and a third stage matrix of the switch, then the group-to-group addressing may be achieved by selecting a wavelength. The TORs in a group would use the same wavelength value or destination group table specific to that group to communicate with any TOR in another group or the same group.

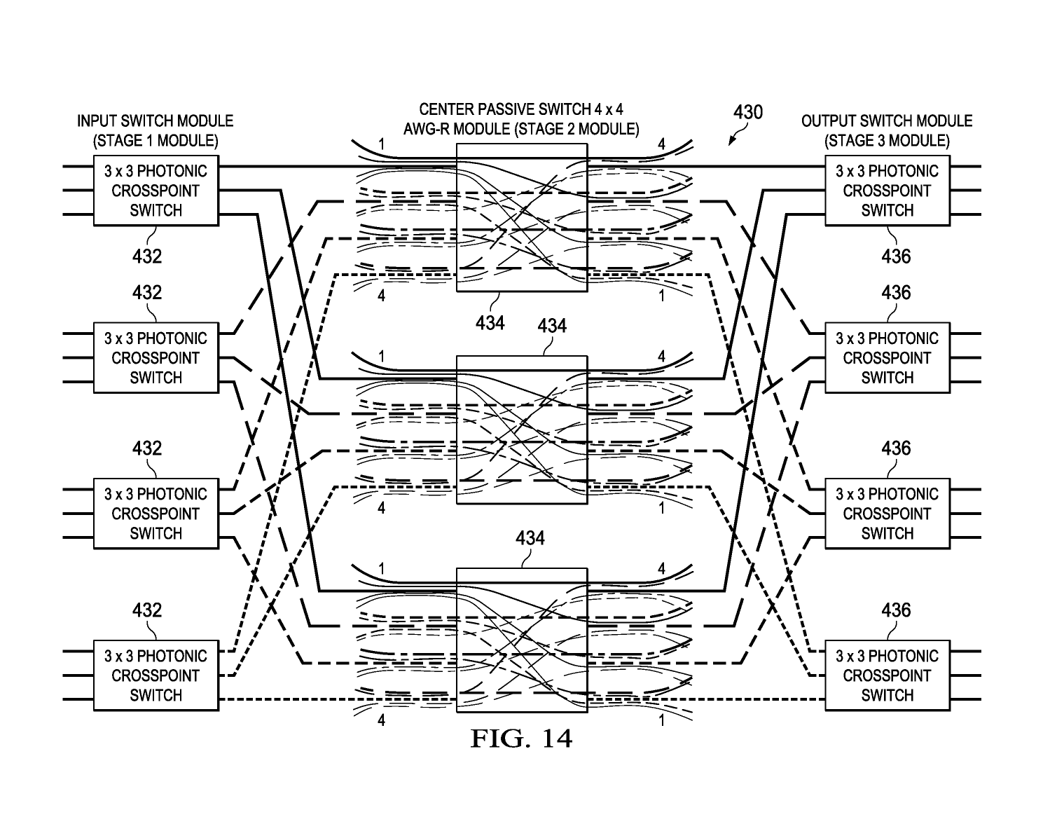

FIG. 14 illustrates switch 430, a three stage CLOS switch with a second stage of AWG-Rs and optical sources capable of fast wavelength tuning providing the input optical signals. Switch 430 contains four first stage switches 432, which are 3×3 photonic crosspoint switches, three third stage switches 436, which are 3×3 photonic crosspoint switches, and three second stage switches 434, which are second stage passive switch 4×4 AWG-R modules, which provide connectivity according to the chosen input wavelength. Second stage switches 434 have the same wavelength routing characteristics, and the first stage modules have a specific wavelength map to connect to the third stage modules. Hence, the inputs of the first stages can be regarded as a group of inputs of the switch which uses a common fixed wavelength map unique to that first stage module to communicate with any output within the required output group module. For a given wavelength, any output on any first stage module always connects to the same third stage module. Therefore, if modules are associated with a group as part of the address, the group part of the address can be programmed into the switch by selecting the wavelength used. This mapping rotates the outputs with a one group offset for each input group offset, ensuring that no two input groups overwrite the same output group at that wavelength.

All outputs of a first stage module are connected to the same input port of different AWG-Rs, while all inputs of the third stage modules are connected to the same output port of different AWG-Rs. Because the AWG-Rs have the same wavelength to port mapping, each first stage module has a unique wavelength map to connect to each third stage module. This map is independent of which input of the first stage and which output of the third stage are to be connected. The first stage modules and third stage modules are photonic switching matrices which are transparent at the candidate wavelengths but provide stage input to stage output connectivity under electronic control. The switching matrices may be electro-optic silicon photonic crosspoints or crosspoints fabricated with InGaAsP/InP semiconductor multilayers on an InP substrate and using semiconductor optical amplifiers.

If the TOR addressing is hierarchical, based on TOR groups associated with first stage modules, each TOR in each TOR group, associated with a specific first stage module, uses the same second stage connectivity to connect to a TOR to a specific target third stage, because both the source TOR's first stage module and the target TOR's third stage module use second stage connections which are the same for each second stage module. This means that the connectivity required of the second stage is the same for that connection irrespective of the actual port to port settings of the input group first stage and the output group third stage. Because the second stage connection is the same, irrespective of which second stage is used, and the second stage connectivity is controlled by the choice of wavelength when the target TOR group address component is known, the wavelength to address that TOR is also known, and the setting of the wavelength agile source can commence. Once the second stage connectivity is set, which second stage will be used may be determined later, which requires the establishment of first stage connections of the source first stage and the target third stage, which are determined in the pipelined control process. This process connects the switch input and switch output to the same second stage plane without using the second stage plane inputs and outputs more than once. This leads to an end-to-end non-contending connection being set up.

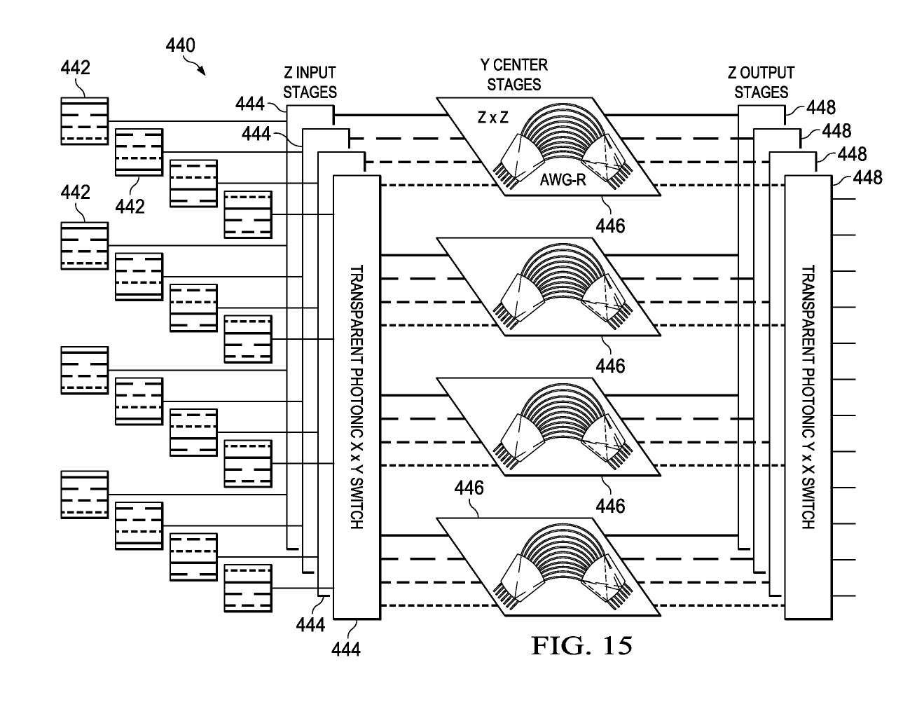

FIG. 15 illustrates photonic switch 440 demonstrating the orthogonality of the switches. Light sources 442 representing agile wavelength-tunable sources are coupled to crosspoint photonic switches 444. Crosspoint photonic switches 444 are coupled to AWG-Rs 446, which are coupled to crosspoint photonic switches 448.

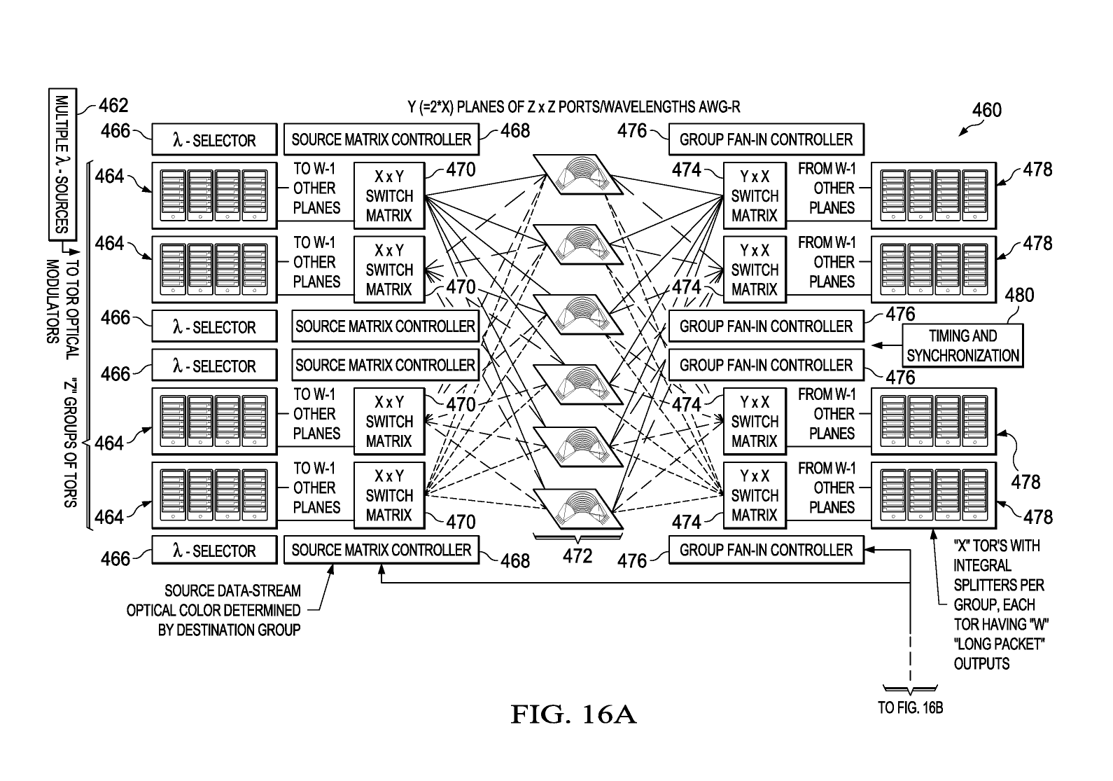

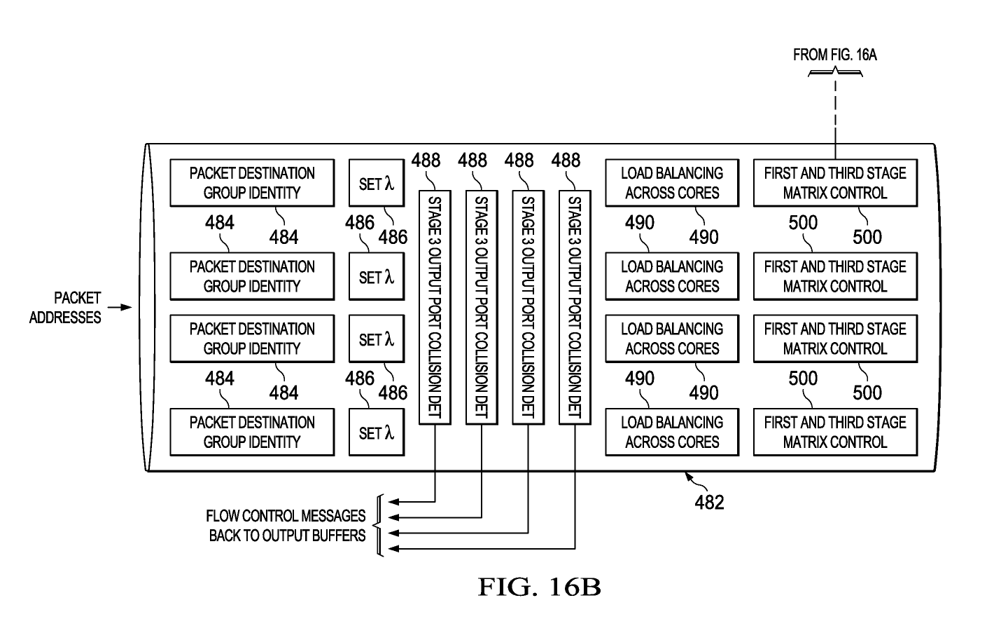

FIGS. 16A-B illustrate photonic switch 460, a large port count photonic switch based on a crosspoint AWG-R CLOS structure and a conceptual pipelined control process implemented between first stage controllers identified as source matrix controllers and third stage controllers identified as group fan in controllers. Photonic switch 460 may be used as a switching plane in a multi-plane structure with a number of identical planes each implemented by a photonic switch 460 in a load-shared structure to provide redundancy against a switch plane failure and a high total traffic throughput. Alternatively, the photonic switch is used without a planar structure in small switching nodes. While only one three stage photonic switch is shown in FIG. 16, there may be multiple photonic switches in parallel. There may be as many parallel switch planes as there are high capacity ports per TOR. W may equal 4, 8, or more. The switching fabric contains the first stage crosspoint switches 470 and third stage crosspoint switches 474, and second stage array of AWG-Rs 472. For 80×80 port second stage AWG-Rs, 12×24 port first stage switches, 24×12 third stage switches, and four outputs per TOR creating four planes, this creates a 3840×3840 port core long packet switching capability organized as four quadrants of 960×960 for an overall throughput of 153.6 Tb/s at 40 Gb/s or 384 Tb/s at 100 Gb/s. In another example, each 100 Gb/s stream is split into four 25 Gb/s sub-streams, and each fabric is replaced with four parallel fabrics, one fabric per sub-stream. In an additional example using an AWG-R of 80×80 ports, 16×32 and 32×16 port crosspoint switches, and 8 planes, a 10,240 port core long packet node organized as eight planes of 1280 ports per switch is created, which requires eight parallel switch plane structures (W=8) of 1280×1280 if 100 Gb/s feeds are switched monolithically, for example using multi-level coding to bring the symbol rate down to around 25 Gsymbols/sec (e.g. quadrature amplitude modulation (QAM)-16 or pulse amplitude modulation (PAM)-16 to fit the data sidebands of the optical signal within the pass-bands of the AWG-Rs. Alternatively, 32 structures if four separate 25 Gb/s sub-streams per 100 Gb/s stream are used. A node based on this switch and with W=8 is capable of handling 1.024 Pb/s of input port capacity. Alternatively for z=40, corresponding to a 100 GHz optical grid and 55+Ghz of usable bandwidth (pass-bands) and using 16×32 first stage switches, 32×16 third stage switches, and 8 ports/TOR, giving 8 parallel load shared planes, gives a capacity of 8×(16×40)=5120×5120 ports=512 Tb/s at 100 Gb/s per port while using simple coding for the 100 Gb/s data streams.

TOR groups 464, defined as the TORs connected to one particular first stage switching module and the corresponding third stage switch module, are associated with agile wavelength generators, such as individual tunable lasers or wavelength selectors 466. Wavelength selectors 466 select one of Z wavelength sources 462, where Z is the number of input ports for one of AWG-Rs 472. Instead of having to rapidly tune thousands of agile lasers, 80 precision wavelength static sources may be used, where the wavelengths they generate are distributed and selected by a pair of Zx1 selector switches at the local modulator. These switches do not have to match the packet inter-packet gap (IPG) set up time, because the wavelength is known well in advance. However, the change over from one wavelength to another takes place during the IPG, so the selector switch is in series with a fast 2:1 optical gate to facilitate the changeover occurring rapidly during the IPG.

The modulated optical carriers from TOR groups 464 are passed through first stage crosspoint switches 470, which are XxY switches set to the correct cross-connection settings by the pipelined control system. The first stages are controlled from source matrix controllers (SMCs) 468, part of the pipelined control system, which are concerned with managing the first stage connections. Also, the SMCs behave so the first stage input ports are connected to the first stage output ports without contention and the first stage mapping of connections matches the third stage mapping of connections to complete an overall end-to-end connection by communication between the SMCs and relevant GFCs via the orthogonal mapper. The first stages complete connections to the appropriate second stages, AGW-Rs 472, as determined by the pipelined control process. The second stages automatically route these signals based on their wavelength, so they appear on input ports of the appropriate third stage modules, third stage crosspoint switches 474, where they are connected to the appropriate output port under control of the third stages' group fan in controllers (GFCs) 476. The group manager manages the connection of the incoming signals from the AWG-R second stages to the appropriate output ports of the third stages and identifies any contending requests for the same third stage output port from the relevant SMC requests received at a specific GFC. In the case when more than one third stage connection requests the same third stage input port from the second stage AWG-R, one or more of the contending third stage inputs may be allocated to another AWG-R plane by communication with the source SMC or SMCs, but packet back-off or delay since is not performed when the third stage output ports are not in contention, because there is enough capacity to move between second stage planes. Crosspoint switches 474 are coupled to TORs 478.

The operation of the fast framed photonic circuit switch with tight demands on skew, switching time alignment, and crosspoint set up time uses a centralized precision timing reference source for other fast synchronous fixed framed systems. Skew is the timing offset or error on arriving data to be switched and the timing variations in the switch from the physical path lengths, variations in electronic and photonic response times, etc. This timing reference source is timing and synchronization block 480 which provides timing to the switch stages by gating timing to the actual set up of the computed connections and providing reference timing for the locking of the TOR packet splitter and buffer/accelerator block's timing. Timing block 480 provides bit interval, frame interval, and multi-frame interval signals including frame numbering across multiple frames that is distributed throughout the system to facilitate that the peripheral requests for connectivity reference known data/packets and known frames so the correct containerized packets are switched by the correct frame's computed connection map.

The lower portion of FIG. 16 shows pipelined control 482. Steps along the pipelined control include packet destination group identification block 484 and set wavelength block 486, both of which may be distributed out to the TOR site or centralized. The pipelined control also includes third stage output port collision detection block 488, load balancing across cores block 490, and first and third stage matrix control block 500, all of which are centralized. These major steps are either completed within one frame period (˜120 ns for 100 Gb/s or ˜300 ns for 40 Gb/s) or divided into smaller steps that themselves can be completed within a frame period, so the SMC and GFC resources implementing each step or sub-step, as appropriate, may be freed up for doing the same computational tasks for the next frame. One alternative is to provide multiple parallel incarnations of parts of the SMC or GFC resource capability to implement long steps in parallel, each incarnation implementing the long step of a different frame and then being reused several frames later. For a step lasting F frames, there are F identical functions in parallel, each loaded with a new task once every F frames in a commutated or “round robin” manner so one of the F parallel functions is loaded with information each frame.

In packet destination group identification block 484, the destination group is identified from the TOR group identification portion of the destination address of the source packets. There may be a maximum of around X packet container addresses in parallel, with one packet container address per input port in each of several parallel flows. X equals the group size, which equals the number of inputs on each input switch, for example 8, 16, 24, or 32. The wavelength is set according to the SMC's wavelength address map. Alternatively, when the TOR is located sufficiently far from the central processing function for the switch, this wavelength setting may be duplicated at the TOR splitter. For example, if the processing beyond the wavelength determination point to the point where a connection map is released takes G microseconds and the speed of light in glass=⅔×c₀=200,000 km/sec, where c₀=speed of light in a vacuum=300,000 km/sec, the maximum distance back to the TOR would be ½ of 200,000*G. For G=2 μs the TORs is within a 200 meters path length of the core controller, for G=4 μs, 400 meters, and for G=6 μs, 600 meters. The maximum length runs in data centers may be upwards of 300-500 meters, and there may be a place for both centralized and remote (at the TOR site) setting of the optical carrier wavelength. The packet destination group identification block may also detect when two or more parallel input packets have identical destination group and TOR addresses, in which case a potential collision is detected, and one of the two packets can be delayed by a frame or a few frames. Alternatively, this may be handled as part of the overall output port collision detection process.

Packet destination group identification block 484 may be conceptually distributed, housed within a hardware state machine of the SMC, or in both locations, because the information on the wavelength to be used is at the TOR and the other users of the outputs of block 487 are within the centralized controller. The packet destination group identification block passes the selected input port to output group connectivity to the third stage output port collision detect and mapper function, which passes the addresses from the SMC to each of the appropriate GFCs based on the group address portion of the address to facilitate the commencement of the output port collision detection processes. This is because each GFC is also associated with a third stage module which is associated with a group and a particular wavelength. Hence, specific portions of the SMCs' computational outputs are routed to specific GFCs so they receive the relevant information subset (connections being made to the GFC's associated TOR group and associated switch fabric third stage dedicated to that TOR group) from the SMCs. Hence, one of the functions of the third stage output port collision detect is to map the same GFC-relevant subset of the SMCs' data to each of the GFCs' input data streams, which are the same number of parallel GFC streams (Z) as there the number of SMC streams. Another function that the third stage output port collision detection block performs is detecting whether two SMCs requesting the same third stage output port (the same TOR number or TOR Group number). When a contention is detected, it may then initiate a back-off of one of the contending requests. Additionally, even when two packet streams are destined for different third stage output ports in a group, the different SMC sources may initially be allocated the same second stage plane, leading to two input optical signals at different wavelengths on one thirds stage input port. The GFC associated with that third stage may detect this as two identical third stage input port addressing requests (plane selections) from the SMCs, and cause all but one of the contending SMC derived connection requests to be moved to different second stage planes. This does not impact the ability to accommodate the traffic, because there are enough second stage planes to handle the traffic load, due to dilation. The SMC may also pass along some additional information along with the address, such as a primary and secondary intended first stage output connection port for each connection from the SMC's associated input switch matrix, which may be allocated by the SMCs to reduce the potential for blocking each other in the first stage as their independent requests are brought together in the third stage output port collision detect block. Hence, those which can immediately be accepted by the GFC can be locked down, thereby reducing the number of connections to be resolved by the rest of the process.

Based on the output identified group for each packet in the frame being processed, packet destination group identification block 484 passes the wavelength information to set wavelength block 486, which tunes a local optical source or selects the correct centralized source from the central bank of continuously on sources. In another example, the wavelength has already been set by a function in the TOR. Because the wavelength selection occurs early in the control pipeline process, the source setup time requirement may be relaxed when the distance to the TOR is relatively low, and the function is duplicated at the TOR for setting the optical carrier wavelength. In FIG. 16, a central bank of 80 sources and two 80:1 selector switches with a series of fast 2:1 light gate for each optical source. The fast light gates may have a speed of about <1 ns, while the selector switches have a speed slower than the fast light gates but much faster than a packet duration.

Third stage output port collision detection block 488 takes place in the group fan in controllers 476, which have received communications relevant to itself via an orthogonal mapper (not pictured) from source matrix controllers 468. The intended addresses for the group of outputs handled by a particular group fan in controller associated with a particular third stage module, and hence a particular addressed TOR group, are sent to that group fan in controller. The group fan in controller, in the third stage output port collision detection process, detects overlapping output address requests from the inputs from all the communications from the source matrix controllers and approves one address request per output port from its associated third stage and rejects the other address requests. This is because each output port of the third stage matrix associated with each GFC supports one packet per frame. The approved packet addresses are notified back to the originating source controller. The rejected addresses of containerized packets seeking contending outputs are notified to retry in the next frame. In one example, retried packet addresses have priority over new packet addresses. The third stage output port collision detection step reduces the maximum number of packets to be routed to any one output port in a frame to one. This basically eliminates blocking as a concern, because, for the remainder of the process, the dilated switch is non-blocking, and all paths can be accommodated.

At this stage, the inputs may be connected to their respective outputs, and there is sufficient capacity through the switch and switch paths for all connections, but the connection paths utilizing the second stages is still to be established to avoid the use of AWG-R outputs for more than one optical signal each. The first stage matrices and the third stage matrices have sufficient capacity to handle the remaining packet connections once the output port collisions are detected and resolved. Connections are then allocated through the second stage to provide a degree of load balancing through the core so the second stage inputs and outputs are only used once. This may be done with a non-dilating switch or a dilating switch by duplicate input address detection by the GFC, which then signals the appropriate SMC or SMCs to change planes. This process may be assisted by the GFC forwarding a list of vacant planes to the SMC or SMCs.

Load balancing across core block 490 implemented between the GFCs and the SMCs communicating via the orthogonal mapper facilitates each first stage output is used once and each third stage input is used once. The second stage plane changes overlapping input signals, resulting in them arriving from different planes, and hence on different third stage input ports. Thus, at the end of this process, each second stage input and output is only used once.

The initial communication from the SMCs to the appropriate GFCs may also include a primary intended first stage output port address and an additional address to be used as a secondary first stage output port address if the GFC cannot accept the primary address. Both the primary and secondary first stage output port addresses provided by the SMC may translate to a specific input port address on the GFC, which may already be allocated to another SMC. The probability that both are already allocated is low relative to just using a primary address. These primary and secondary first stage output ports are allocated so that each output port identity at the source SMC is used at most once, because, in a 2:1 dilating first stage, there are sufficient output ports for each input port to be uniquely allocated two output port addresses. These intended first stage output port addresses are passed to the appropriate GFCs along with the intended GFC output port connection in the form of a connection request. Some of these connection requests will be denied by the GFC on the basis that the particular output port of the GFC's associated third stage switch module is already allocated (i.e. overall fabric output port congestion), but the rest of the output port connection requests will be accepted for connection mapping, and the requesting SMCs will be notified. When both a primary and a secondary first stage output address, and consequent third stage input address, was sent by the SMC, the primary connection request may be granted, the secondary connection request may be granted, or neither connection request is granted.

In one situation where the primary request is granted, when the connection request is accepted, the third stage input port implied by the primary choice of first stage output port and consequent third stage input port, translated through the fixed mapping of the second stage at the correct wavelength, is not yet allocated by the GFC for that GFC's third stage input port for the frame being computed. The request is then allocated, which constitutes an acceptance by the GFC of the primary connection path request from the SMC. The acceptance is conveyed back to the relevant SMC, which locks in that first stage input port to primary output port connection and frees up the first stage output port which had been allocated to the potential secondary connection, so it can be reused for retries of other connections.

In another situation where the secondary request is granted, the connection request is accepted, but the third stage input port implied by the primary choice of first stage output port, and hence second stage plane, is already allocated by the GFC for that GFC's third stage for the frame being computed, but the SMC's secondary choice of first stage output port, and hence second stage plane and third stage input port, is not yet allocated by the GFC for that GFC's third stage for the frame being computed. In this example, the GFC accepts the secondary connection path request from the SMC, and the SMC locks down this first stage input port to first stage output port connection and frees the first stage primary output port for use in retries of other connections.

In an additional example, the overall connection request is accepted, because the third stage output port is free, but the third stage input ports implied by both the primary and secondary choice of first stage output port, and hence second stage plane, are already allocated by the GFC for other connectivity to that GFC's third stage for the frame being computed. In this example, the GFC rejects (denies to grant) both the primary and secondary connection path requests from the SMC. This occurs if neither the primary or secondary third stage input ports are available. This results in the SMC freeing up the temporarily reserved outputs from its output port list and retrying with other primary and secondary output port connections from its free port list. A pair of output port attempts may be swapped to different GFCs to resolve the connection limitation.

Overall, the SMC response to the acceptances from the GFC is to allocate those connections between first stage inputs and outputs to set up connections. The first stage connections not yet set up are then allocated to unused first stage output ports, of which at least half will remain in a 2:1 dilated switch, and the process is repeated. The unused first stage output ports may include ports not previously allocated, ports allocated as primary ports to different GFCs but not used, and ports allocated as secondary ports but not used. Also, when the GFC provides a rejection response due to specified primary and secondary input ports to the third stage already being used, it may append its own primary or secondary third stage input ports, and/or additional suggestions, depending on how many spare ports are left and the number of rejection communications. As this process continues, the ratio of spare ports to rejections increases, so more unique suggestions are forwarded. These suggestions usually facilitate the SMC to directly choose a known workable first stage output path. If not, the process repeats. This process continues until all the paths are allocated, which may take several iterations. Alternatively, the process times out after several cycles.

When the load balancing is completed or times out, the SMCs generate connection maps for their associated first stages and the GFCs generate connection maps for their associated third stages for use when the packets in that frame propagate through the buffer and arrive at the packet switching fabric of the fast photonic circuit switch. When the load balancing is complete, the load balancing has progressed sufficiently far, or the load balancing times out, the first stage SMCs and third stage GFCs, respectively, generate connection maps for their associated first stages and third stages. These connection maps are small, as the mapping is for individual first stage modules or third stage modules and is assembled alongside the first stage input port wavelength map previously generated in the packet destination group identification operation. Table 4 illustrates an example of an individual SMC (SMC #m) connection map and Table 5 illustrates an example of a GFC connection map for a 960×960 port 2:1 dilated switch based on an 80×80 port AWG-R and 12×24 crosspoint switches. In this example, two connections (connections A and B) from the SMC terminate on the GMC at wavelength 22. Hence, these two tables show Connection A, completing connections from TOR group #m, TOR #5 to TOR group #22, TOR #5 and Connection B, completing from TOR group #m, TOR #7 to TOR group #22, TOR #11. The remaining SMC #m connections are to other TOR groups, and the remaining GFC #22 connections are to SMCs from other TOR groups but to group #m.

TABLE 4

| Input Port | Wavelength | Output Port |
|---|---|---|
| 1 | 7 | 23 |
| 2 | 44 | 16 |
| 3 | 38 | 15 |
| 4 | 53 | 20 |
| 5 (Connection A) | 22 | 8 |
| 6 | 51 | 7 |
| 7 (Connection B) | 22 | 4 |
| 8 | 9 | 10 |
| 9 | 6 | 21 |
| 10 | 71 | 5 |
| 11 | 11 | 14 |
| 12 | 3 | 18 |

TABLE 5

| Output Port | Input Port |
|---|---|
| 1 | 15 |
| 2 | 23 |
| 3 | 17 |
| 4 | 6 |
| 5 (Connection A) | 8 |
| 6 | 1 |
| 7 | 14 |
| 8 | 19 |
| 9 | 21 |
| 10 | 22 |
| 11 (Connection B) | 4 |
| 12 | 3 |

The SMC and GFC functions may be implemented as hardware logic and state machines or as arrays of dedicated task application-specific microcontrollers or combinations of these technologies.

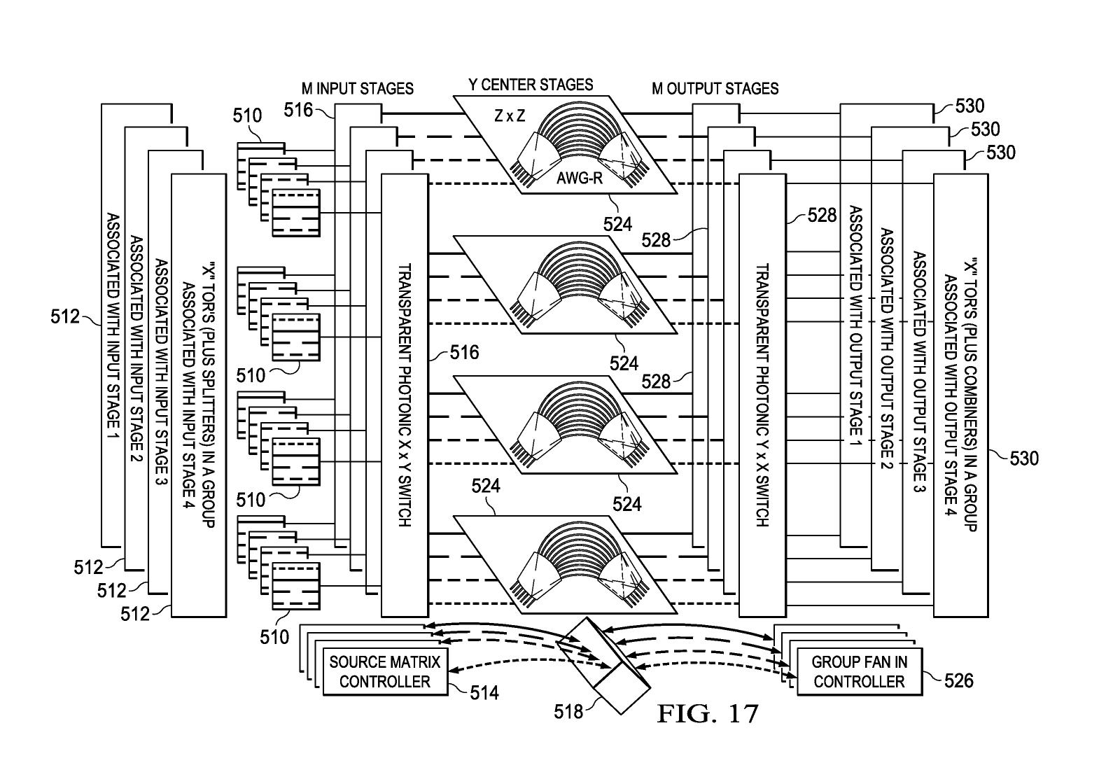

FIG. 17 illustrates an abstracted orthogonal representation of a photonic switching system. TOR groups 512 each contain X TORs and splitters in a group associated with a first stage. The short packet processing and routing is not shown in FIG. 17, but the long packet photonic switching path using containers is shown. Wavelength selectors 510 set the wavelength according to the destination group, based on the output of SMCs 514. SMCs 514 communicate their partial connection processing results with orthogonal mapper (OM) 518, a hardware device, which communicates with GFCs 526, and vice versa. SMCs 514 also control the configuration of photonic switches 516, XxY switch modules. The outputs of photonic switches 516 are switched by AWG-Rs 524, ZxZ AWG-Rs, based on the wavelength from wavelength selector/source 510. The output of AWG-Rs 524 are then switched by photonic switches 528, YxX switches, they are received by TOR groups 530, which contain X TORs and combiners associated with third stages.

The orthogonal mapper provides a hardware-based mapping function so the SMCs' connection requests and responses are automatically routed to the appropriate GFC based on the destination group address, and the GFCs' connection responses and reverse requests are routed to the appropriate SMC, based on the source group address. Functionally, the orthogonal mapper is a switch with the SMC→GFC routing of information controlled using the destination group address as a message routing address and the GFC→SMC routing is controlled using the source group address as a message routing address.

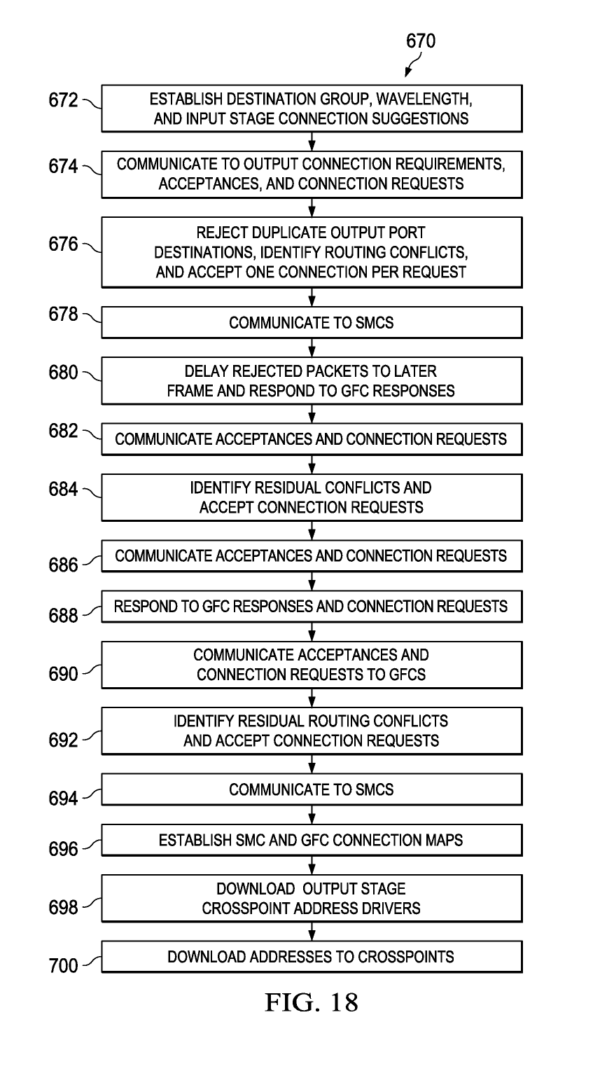

FIG. 18 illustrates flowchart 670 for a method of connecting a TOR of one TOR group to a TOR of another TOR group. Initially, in step 672, the SMC establishes the destination group, wavelength, and first stage connections. In one example, a primary first stage connection (a first stage input port to output port connection) and a secondary first stage connection (a first stage input port to alternative output connection) are established. Step 672 may take one to several frames (e.g. four frames). When step 672 takes more than one frame, it may be carried out in more than one block in parallel, where the blocks process different frames. In another example, the tasks of this step are broken down into several sub-steps, each of which is completed in less than a frame period by its own dedicated hardware or processing resources.

Next, in step 674, the OM communicates third stage connection requirements, in the form of primary and secondary connection requests, from the SMCs to the appropriate GFC. Step 674 may take one frame.

Then, in step 676, the GFC rejects duplicate third stage output port destinations and accepts one connection per destination port. Also, the GFC identifies connection routing conflicts where more than one SMC connecting to the GFC's third stage matrix through the same second stage matrix. Step 676 may take one to several frames (e.g. four frames). This step may be carried out in more than one block in parallel, processing different frames. In another example, the tasks are broken down into several sub-steps, each of which is completed in less than a frame period by separate dedicated hardware.

In step 678, the OM communicates the rejected and accepted output destination port requests to the appropriate SMCs, along with the accepted primary and secondary connection requests, which may take one frame.

Next, in step 680, the SMC causes rejected (contending) containerized packets those contending for the same third stage output port to be delayed to a later frame, for example using feedback to control for buffer/padder. The contending packets are the packets contending for the same third stage output port. The SMC locks in accepted primary and secondary connection requests and returns any unutilized first stage output ports to the available list. Also, the SMC responds to the responses with new primary and secondary first stage connection requests or accepts the reverse requests or connection assignments from the GFC based on the SMC's associated first stage output port occupancy. Step 680 may take one to three frames (e.g. 2 frames). Hence, this step may be carried out in two or three blocks in parallel, processing different frames. Alternatively, the tasks are broken down into two or three sub-steps, each of which is completed in less than a frame period by its own dedicated hardware.

Then, in step 682, the OM communicates the acceptances and new primary and secondary requests to the appropriate GFCs for those accepted output port connections for which primary and secondary connection requests have not been accepted by the GFC. Step 682 may take one frame.

In step 684, the GFC identifies residual routing conflicts and accepts the primary and secondary requests from the SMC which align with available ports, again rejecting those which do not. Optionally, the GFC formulates new reverse requests based on its map of available inputs. Step 684 may take one or two frames. This step may be carried out in two blocks in parallel, processing different frames. The tasks of this step may be broken down into two sub-steps, each of which is completed in less than a frame period by its own dedicated hardware.

Next, in step 686, the OM communicates the acceptances and requests to the appropriate SMC, which may take one frame.

Then, in step 688, the SMC responds to the acceptances and requests from the GFC, which takes one or two frames. This step may be carried out in two blocks in parallel, processing different frames, or the tasks of this step may be broken down into two sub-steps, each of which is completed in less than a frame period by its own dedicated hardware.

In step 690, the OM communicates the acceptances and requests from the SMC to the appropriate GFCs in one frame.

Next, in step 692, the GFC identifies residual routing conflicts and generates primary, secondary, and tertiary requests based on the input port availability of its associated third stage switch module. Alternatively, the GFC sends a list of remaining available ports to the SMCs in question. At this point in the process, there are many spare ports and few SMCs contending for them. Step 692 takes one or two frames. Hence, this step may be carried out in two blocks in parallel, processing different frames or the tasks of this step may be broken down into two sub-steps, each of which is completed in less than a frame period by its own dedicated hardware.

Then, in step 694, the OM communicates the response from the GFCs to the appropriate SMCs in one frame.

The connection map with the SMC and GFC connections is established in one or two frames in step 696. This is performed by the SMC and GFC communicating via the OM. Hence, this step may be carried out in two blocks in parallel, processing different frames, or it may be broken down into two sub-steps, each of which is completed in less than a frame period by its own dedicated hardware.

In step 698, the first stage and third stage crosspoint address drivers are downloaded by the SMCs and GMCs in one frame.

Finally, in step 700, the addresses are synchronously downloaded to the crosspoint switches when toggled from the padder/buffer. This takes one frame.

The fifteen steps in flowchart 670 last one or more packet interval(s). Steps which last for multiple packet intervals may be broken down into sub-steps with durations of one packet interval. Alternatively, multiple instantiations of the function run in parallel in a commutated control approach for that part of the control process. In one example, where a hardware state machine is used, the computation and set-up of the connection map connecting the TORs to each other takes 26 frames to complete. In this example, there are 26 frames in progress being processed in various parts of the pipelined control structure at a time.

When the process takes 26 frames, at 300 ns per frame the process takes around 7.8 μs. However, for 120 ns per frame, the process takes about 3.12 μs. In both cases, because the connection data (the source and destination addresses) may be gathered from the incoming traffic to the splitter early in the processes taking place in the overall splitter, padding and acceleration functions, the delay due to control pipeline processing can occur on a parallel path to the containerized packet delays through the buffer/padder/accelerator blocks, which may result in the order of a 16-40 frame delay. Thus, this processing delay does not necessarily add to the delay through the switch fabric, if it takes less time than the delay through the splitter's containerized packet processing.

Each of the steps performed by the SMC may take place in a separate dedicated piece of SMC hardware. The OM may be layered by parallel paths between the SMCs and GFCs step outputs to provide fast orthogonal mapping. The OM connects the SMCs to the GFCs and vice versa, and acts as a hardwired message mapper. When addressing is in the form of TOR group and TOR number within the TOR group, and communications between the SMCs and GFCs include headers of the source TOR group and destination TOR group, the OM may become a series of horizontal data lines or busses transected by a series of vertical data lines or busses with a connection circuit between each horizontal and vertical line or bus where they cross. This connection circuit reads the TOR group portion of the passing address header with the destination TOR group for messages associated with the GFC and the source TOR group for messages to the associated SMC. If the address matches the address associated with its output line, the OM latches the message into memory associated with that output port. If the address does not match, the OM takes no action. Thus, the messages sent along horizontal data lines from the SMCs are latched into data memories associated with vertical lines feeding to the appropriate GFCs based on the group address of that GFC. The data in the memories is then read out and fed to the appropriate GFCs synchronously to a vertical clock line, which daisy chains through the memory units and triggers the memory unit to output its message or messages. The clock is delayed by the memory unit until it has output its message. When there is no message to be sent (no connection request), the clock is immediately passed through. Then the clock is sent to the next memory unit in the vertical stack. This creates a compact serialized stream of messages to the recipient GFCs containing the relevant messages from only the SMCs communicating with a particular GFC, and very small gaps between the messages.

OM 518 has two groups of mapping functions. One group of mapping functions connects SMCs 514 to GFCs 526, while the other group of mapping functions connects GFCs 526 to SMCs 514. With the overall SMCs and GFCs simultaneously processing other parts of the connection derivation for the prior and following packets, the messages between the SMCs and GFCs may collide with a frame messaging with only a single OM per direction. In an example, there are three SMC to GFC communications per frame and three GFC to SMC communications per frame. Hence the OMs, SMCs, and GFCs may be configured in functional block groups, each of which handles one or more steps or sub-step of the process.

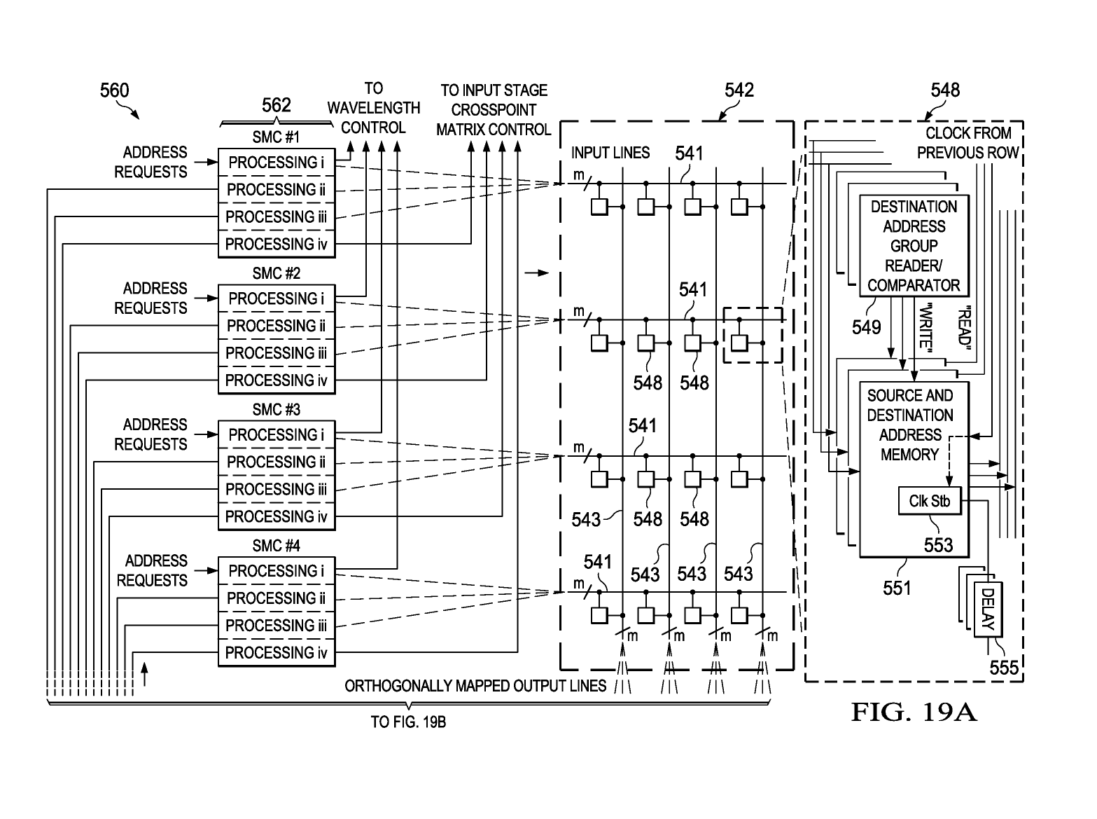

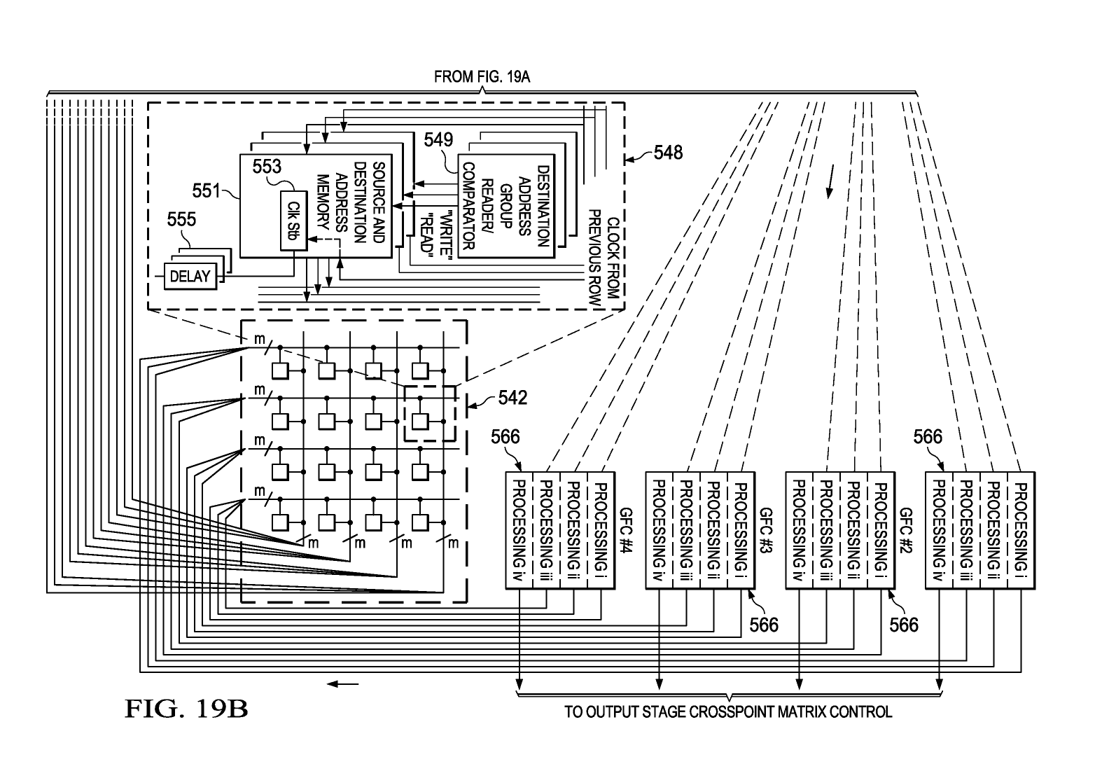

FIGS. 19A-B illustrate an overall orthogonal mapper function 560, an example of an orthogonal mapper used in FIG. 17, which contains two orthogonal mappers in inverse parallel—one mapping SMC outputs to the relevant GFC inputs, and one mapping GFC outputs to the relevant SMC inputs. The connection requests enter SMCs 562. After determining the routing information, SMCs 562 pass the routing information to the appropriate GFCs. This may be done by sending messages through OM 542 which are automatically routed through the OM. The routing information is appended with the SMC TOR group address and the GFC group address. The SMC TOR group address is hard coded into the SMC, and the GFC group address is part of the incoming connection request from the source TOR. This information is also used to determine the optical wavelength. OM 542 contains input lines 541, output lines 543, and memory 548. Memory 548 contains destination address group reader 549, source and destination address memory 551, which may contain clock source 553, and delay element 555. Clock source 553 may be present in the head (top) intersection of the vertical columns, which are triggered by a frame boundary from the master reference, producing a pulse which propagates down the vertical columns to assemble the output messages from the memory units in a sequence. Thus, the GFCs receive messages from the first row of SMCs first and the last row last, leading to a potential systemic favoritism. Alternatively, the clock line are in a loop, and the intersections of the rows and columns have clock generators and their clock source, which is active (generates the propagated pulse), and shifts by one row every frame. This rotates the sequencing, providing less systemic favoritism. The messaging from the SMCs is sent into the first layer of the OM, where, at the appropriate vertical output line, the GFC address associated with that line is detected, and the message is stored into the source/destination address memory. After receiving a clock pulse (or generating a clock pulse) on the output (vertical) line, the clock at the source/destination address memory writes its contents to the output line to the GFC associated with that line, and sends a clock pulse to the next memory, which then abuts its information behind the tail end of the message from the previous source/destination address memory, thereby creating a compact flow of information in a specific format to the GFC associated with the vertical line. The GFC communicates with the SMC in a similar manner, sending a formatted set of messages through OM 548, configured to map inputs from the GFCs to the appropriate target SMCs. This information is mapped through the OM by a similar process, creating a compact stream of data for the relevant SMCs associated with the vertical lines. When the SMC communicates to the GFC, this process is repeated until sufficient connections have been established or the process times out. Then, the cross-connection maps are written out for the first stages by the SMCs and the third stages by the GFCs 566.

The messages contain a source group and multiple destination group addresses, plus the addresses of the connections requested by the SMC, up to a maximum of X primary and X secondary addresses (where X equals the number of inputs per first stage matrix) when a particular first stages module's inputs are terminating on the same third stage group and third stage switch module. Hence, an individual SMC may have multiple simultaneous connection requests for a GFC when its packet streams are destined for that GFC. For example, the message length, TOR source group address, TOR destination group address, TOR source and destination numbers, primary port suggestions, and secondary port suggestions may be one byte each. This is a total of six bytes for one connection and thirty nine bytes for twelve connections. Multiple messages may be output from multiple SMCs on one GFC line when a large number of source TOR groups are trying to converge on one destination TOR group. Thus, the messaging structure does not saturate until beyond the point where the TOR group associated with the destination GFC is complete. For example, when 24 connection requests come from 24 separate SMCs, there is an 144 byte long sequence, which take about 120 ns for the case of 24×100 Gb/s packet streams all from different groups, or about 300 ns for the case of 24×40 Gb/s packet streams all from different groups, corresponding to about 1.2 GB/s (10 Gb/s) and 480 MB/s (3.84 Gb/s), respectively. However, in many situations, there are fewer connection requests, for example 0, 1, or 2 requests per GFC from each SMC. When the initial function is completed without putting forward requested connections, there is an additional pass through the two OMs and another processing cycle in the SMCs and GFCs, but the messaging is reduced to 96 bytes, dropping the rate to 800 MB/s or 320 MB/s, respectively. The paths through the OM may be nibble wide, byte wide, or wider, for example to suit the choice of implementation technology.

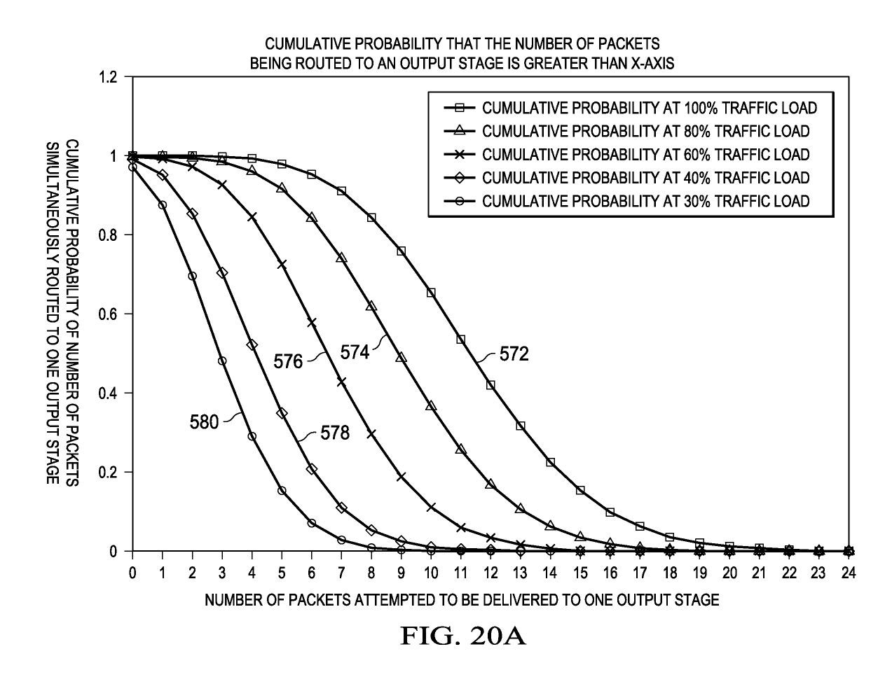

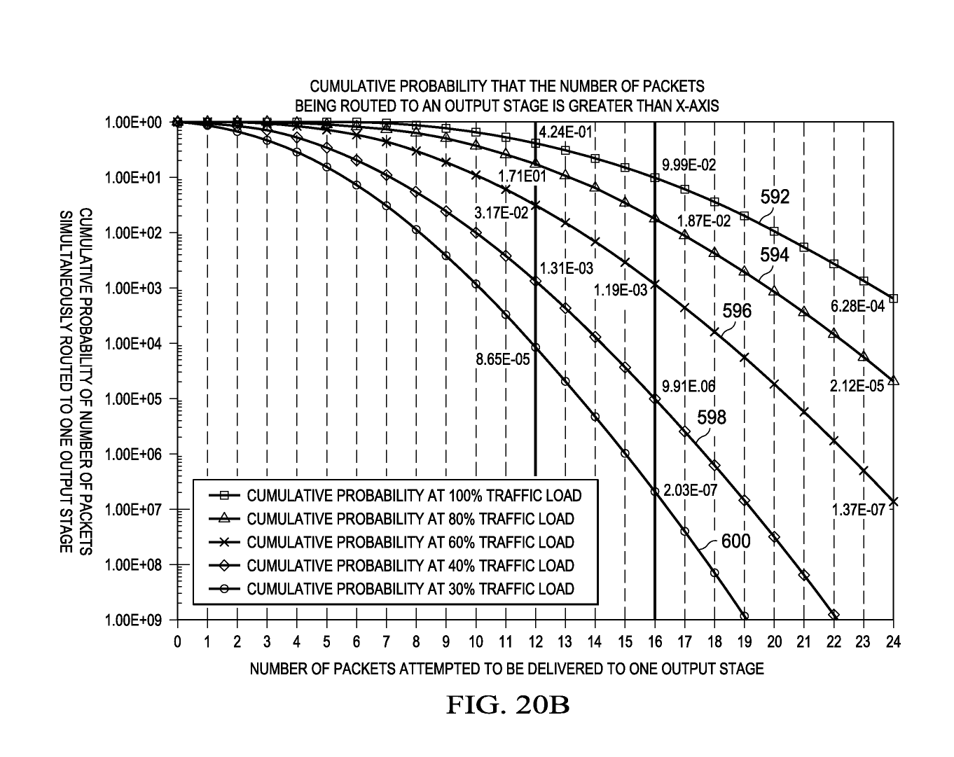

FIGS. 20A-B illustrates graphs for simulation models which show the probability that there will be more than a given number of simultaneous requests. FIG. 20A illustrates a graph from a simulation model of a control approach which shows the probability that there will be more than a given number of simultaneous requests to a specific third stage and its corresponding GFC for the a 960 port switching fabric shown in FIG. 16. This is plotted for various levels of overloading of that switch fabric.

Packet switches handle statistically based traffic—any input may select any output at any time. To control the level of transient overloads and packet delays or discards, traditionally levels below an average traffic level of ˜30% are used to prevent the peak traffic from regularly exceeding 100%. The graphs of FIG. 20A show the probability of more than a given number of simultaneous requests which may be received by a specific GFC of the switch in FIG. 16 under random traffic conditions. Curve 580 shows the cumulative probability of the number of containerized packets per frame simultaneously accessing a specific GFC for a 30% traffic load, curve 578 shows the probability distribution for a 40% traffic load, curve 576 shows the probability distribution for a 60% traffic load, curve 574 shows the probability distribution for an 80% traffic load, and curve 572 shows the probability distribution for a 100% traffic load. For a 100% traffic load, on average only 58% of the packets may be routed to their destinations (94X), with the remaining 42% of packets being blocked due to lack of output port capacity on the switch module associated with the GFC and reflecting lack of input capacity in the destination TOR. With a lower traffic level, the percentage of packets that do not reach their destination drops dramatically. For an 80% traffic load, 17% of packets do not reach their destination, at a 60% traffic load, 3% of packets do not reach their destination, at a 40% traffic load, 0.13% of packets do not reach their destination, and at a 30% traffic load, 1 in 12,000 packets do not reach their destination due to a lack of output port capacity on a specific third stage module associated with a specific GFC. Hence, control system messaging which does not significantly add to this level of loss under overload conditions beyond the 30% traffic load may be satisfactory.

FIG. 20B illustrates a graph of the same model used in FIG. 20A plotted on a logarithmic scale, for the cumulative probability for a number of packets simultaneously being routed to one third stage. Curve 600 shows the cumulative probability for a 30% traffic load, curve 598 shows the cumulative probability for a 40% traffic load, curve 596 shows the cumulative probability for a 60% traffic load, curve 594 shows the cumulative probability for an 80% traffic load, and curve 592 shows the cumulative probability for a 100% traffic load. With a message structure which overloads beyond 24 attempted messages per GFC there is a probability of 0.06% of not being able to process all the received containerized packet addresses, whether or not they exceed the capacity of the associated third stage module (and associated destination TOR inputs) to handle them for the allocated packet addresses to a specific GFC at a 100% traffic load. This improves to around 0.0002% at 80% of overload, to one frame in 7,000,000 at 60% traffic load, at 1 in 2.4*10¹⁰ at 40% traffic load, and 1 in 1.3*10¹³ at 30% traffic load. A reduced message overload of 16 messages before an overload achieves a 1 in 5,000,000 overload probability at 30% traffic load, and a 1 in 840 overload probability at 60% traffic load. This reduces the worst case messaging rate per frame for messaging transactions across the OM's SMC→GFC paths from 1.2 GB/s to about 800 MB/s for a 120 ns frame, with a substantially lower average.

Once the potential output contention is resolved, a maximum of 12 connections per GFC and SMC retain some primary and secondary connection request/grant process messaging, which may be immediately accepted in the first cycle between the SMC and GFC, leaving the residual messaging at well below the peak rate.

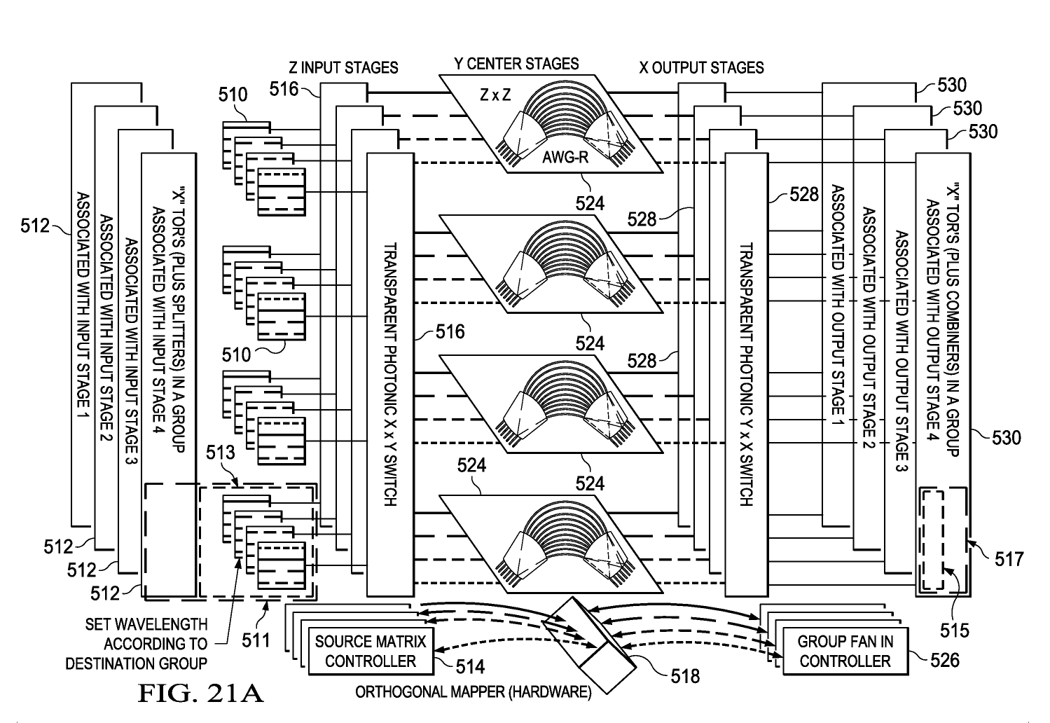

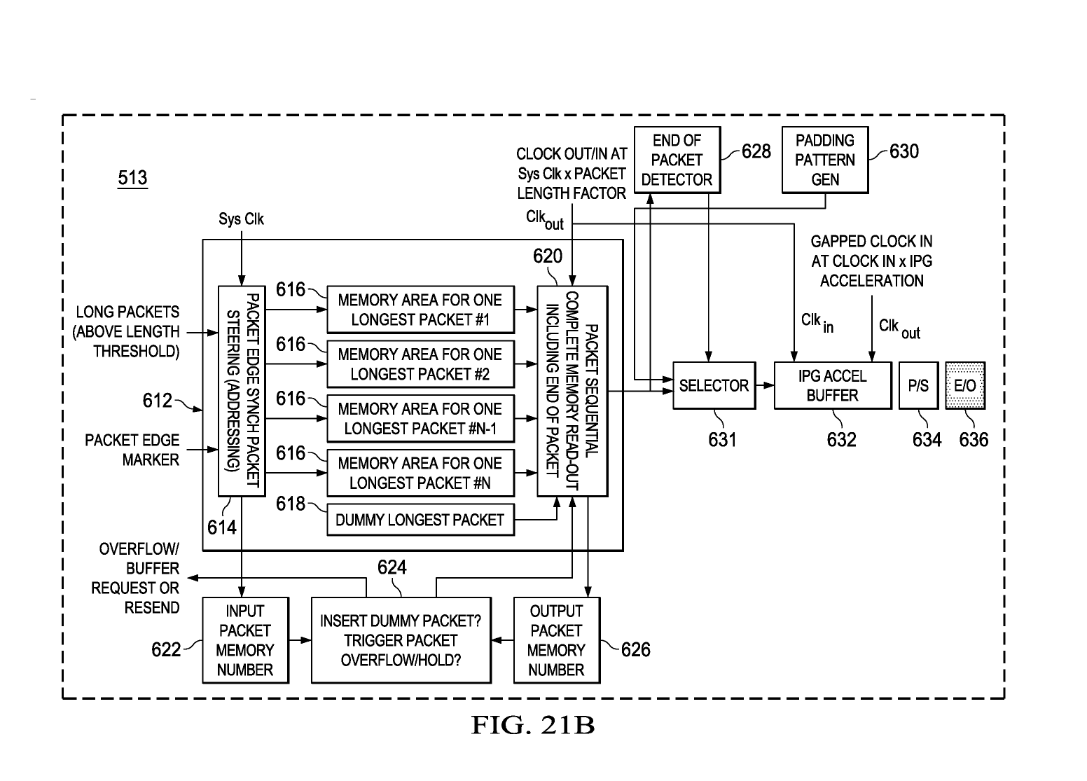

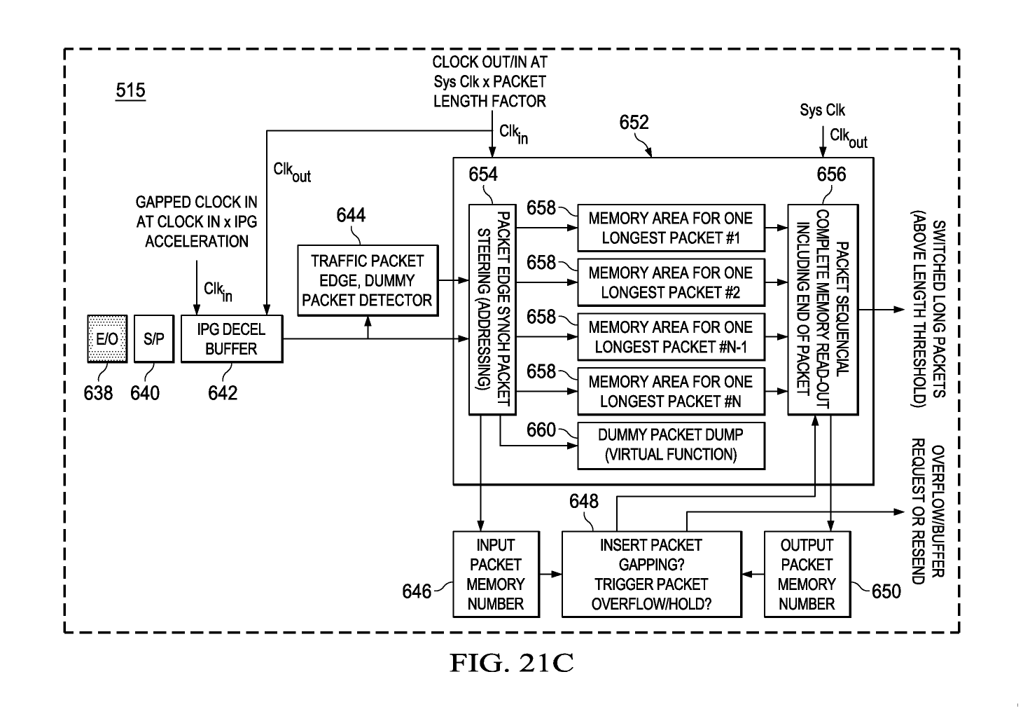

FIGS. 21A-C illustrate a high level view of an enhanced accelerator which incorporates both an IPG gap extension and a padding/buffer functionality to accelerate the packet rate and accommodate the shortest of the long packets. The streams of long packets coming from the long/short packet stream splitter are fed into two accelerators in series. The first accelerator accelerates the packets to a higher frame rate and lengthens the packets by adding wrapper overhead bytes and empty payload padding bytes after the packet, so packet containers are at the same length with a packet payload space capable of supporting the maximum packet length, and the packet containers have a constant duration, facilitating synchronous switching. The second accelerator compresses the packet containers so the inter-packet gap or inter-container gap is enlarged.

In FIG. 21A, an abstracted orthogonal representation of a photonic switching system is illustrated. TOR 511 contains TOR splitter 519. TOR 517 contains TOR combiner 521. Padded containerized packet traffic streams are fed from splitters 519 into the associated electro-optic converters 510 for conversion to the appropriate wavelength to implement the group-to-group connection in the AWG-R second stages. Then, the packet streams are fed into first stage 516, second stage 524 and third stage 528 before emerging and being fed into the input of the optical receiver of flow combiner 515 of the destination TOR 517. The connectivity of the core switch, including first stage 516, second stage 524 and third stage 528 is controlled from the pipelined control system including the source TOR group associated SMCs 514, TOR group-associated GFCs 528, with orthogonal mappers 518 between the SMCs and the GMCs.

In FIGS. 21B-C, the long packet stream enters padder/buffer 612 from the long/short packet splitting switch output. FIG. 21B illustrates an example TOR splitter, which may be used, for example, as TOR splitter 517. The long packet stream contains packets above a threshold. The packet boundaries, which are available from the switch or switch control, are also input to padder/buffer 612. The packets enter packet edge synch packet steering block 614, where the packets are steered to the payload areas of memory arrays 616. The payload areas of memory arrays 616 are a subset of the total locations of memory arrays 616, where the memory payload areas are sufficiently large to accommodate the longest length packets. As well as the payload areas, memories 616 may have areas reserved for wrapper header byte insertion, for example to carry the packet stream sequence number for use in reconstituting the packet sequence integrity in the destination combiner and the packet TOR level source and destination address, for example to confirm valid connectivity across the photonic switch.

After the packet is fully entered into the memory area and the packet boundary is detected or indicated, the next packet is fed into the next memory payload area, whether or not the first memory payload area is full. This process continues until the memory payload areas are full, and begins to reset the first memory and then rewrites the first memory payload area with a new packet. Because the packet boundary edge detection is used to change the routing of the incoming stream of long packets on the receipt of the boundary marker, a memory payload area contains one stored packet, and may not be full. The rate of this process depends on the input packet length because, at a constant system clock speed, the length of time to enter a packet into a memory payload area is proportional to the packet length, which may vary from just above the long/short threshold (e.g. 1000 bytes) to the maximum packet length (e.g. 1500 bytes).

In parallel with writing the packets into the memory payload area, the wrapper header area of the memory is loaded with header contents such as a fixed preamble, source TOR, TOR group address, destination TOR, TOR group address, and sequence number of the packet from the connection request handler shown in FIG. 2, and is fed to the buffer/delay via switch 150.

While input packets are being written into some memory area locations, other memory area locations are being read out cyclically by output packet memory number 626. Instead of reading out just the packet, the entire memory is read out, creating a fixed length readout equivalent to the length of the longest packet plus a fixed length header. For packets with the maximum length, the entire packet plus header is read out. However, for packets less than the maximum length, the header plus a shorter packet are read out, followed by the packet end, and the empty memory locations. The end of packet is detected by end of packet detector 628, which connects padding pattern generator 630 via selector 631 to fill the empty time slots. Hence, the packets are padded out to a constant length and to a constant duration by padding pattern generator 630. The addition of extra padding bits causes the output to contain more bytes than the input, so the output clock is faster than the input clock. This advances the readout phase of the output side of the memory areas relative to the input phase when the input is full length packets, while the input phase of writing into the memory areas is advanced relative to the output phase when a significant amount of shorter packets are processed. Hence, the phasing of the input memory area commutator is variable, while the output phasing of the commutator is smooth. The choice of the output clock rate balances the clock speed ratio to the probability of shorter length packets.

The accelerator clock (Sys Clk) is increased above the calculated level based on the traffic statistics for the long/short split level chosen. For example, for a calculated accelerated clock of 1.05 Sys Clk from the process leading to the curves of FIGS. 4-6, it may be set to 1.065 Sys Clk, and for a calculated accelerated clock of 1.1 Sys Clk, it may be set to 1.13 Sys Clk. Even when traffic with the nominal mix of packets is present, the output phasing tends to advance on the input phasing, which can continue with even denser levels of shorter packets. In other words, with the output trying to output slightly more padded data, the output is always catching up on the input to create a situation of underflow. The input packet memory area number 622 of the memory area being loaded is compared with the output packet memory number 626 in decision block 624. When the output packet memory area number gets too close to the input memory area number, instead of the output readout proceeding to the next memory area, it will read out a dummy packet from dummy packet block 618 before resuming normal cyclic operation. This will retard the read out memory phasing relative to the input memory area phasing. When a very large number of packets close to the threshold length are received close together, back pressure may be triggered to the source to slow down the stream of packets or to drop and resend an incoming packet.

Selector 631 selects the packet from packet readout block 620 when the end of packet is detected by end of packet detector 628. The inter-packet gap is then increased by accelerator 632. After the packet is accelerated, it is converted from parallel to serial in parallel-to-serial block 634, and then converted from an electrical signal to an optical signal be electrical-to-optical converter 636, which propagates the padded containerized packet stream into the photonic switching fabric illustrated in FIG. 21A.

FIG. 21C illustrates TOR combiner 515, which may be used, for example, as TOR combiner 521. The padding/buffering decelerator on the other side of the photonic switch provides the inverse functions to reduce the IPG, strip off the padding and wrapper header contents, and return the packet stream rate to that of the system clock. The packet is received from the switching fabric illustrated in FIG. 21A and converted from the optical domain to the electrical domain by optical-to-electrical converter 638. Then, the packet is converted from serial to parallel by serial-to-parallel converter 640. Next, the inter-packet-gap is decreased by decelerator 642.

The traffic packet edge is detected by packet detector 644. The packet and packet edge proceed to padder/buffer 652, where the packet edge is synched by block 654. The packet is placed in one of memory areas 658. Packets are then read out by packet read-out 656. Dummy packets are read from dummy packet block 660 when the input packet memory number 646 approaches the output packet memory number 650 as determined by block 648.

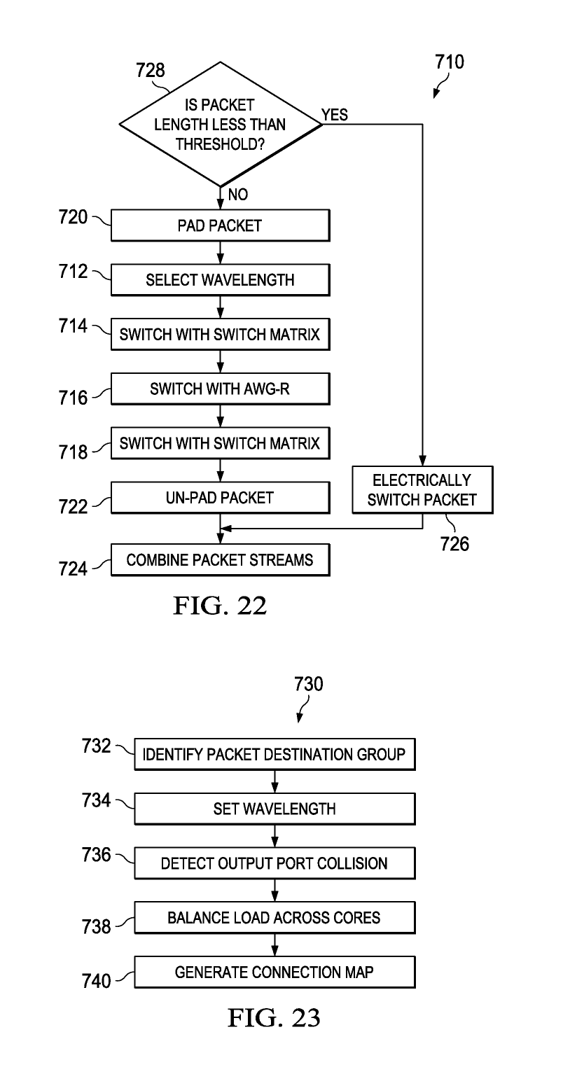

FIG. 22 illustrates flowchart 710 for a method of optical switching. Initially, in step 728, the system determines whether the length of the packet is less than a threshold. When the length of the packet is less than the threshold, the packet is routed to step 726, where it is electrically switched. When the length of the packet is greater than or equal to the threshold, the packet is photonically switched, and proceeds to step 720.

In step 720, the packet is padded so the packets are at a constant maximum packet length. In one example, the maximum packet length is 1500 bytes. The packets may be padded by writing packets into multiple parallel buffers of a constant length, and then reading out the entire buffer. The clock rate for the read-out may be higher than the clock rate for writing the packets.

Then, in step 712, a wavelength is selected. In one example, a wavelength is selected by choosing one of a variety of wavelength sources. In another example, the wavelength is selected by changing the wavelength of an adjustable light source.

Then, in step 714, the signal at the selected wavelength is switched, for example by a photonic switch matrix under control of an SMC.

Next, in step 716, the signal is switched by an AWG-R. This switching is based on by the wavelength of the source selected in step 712.

In step 718, the signal is again switched, for example by another photonic switch matrix under the control of a GFC.

The packet is un-padded in step 722. This may be done by writing the packets into several parallel buffers, and reading out the packet without padding.

Finally, in step 724, the switched photonic packet stream and the switched electrical packet stream are combined.

FIG. 23 illustrates flowchart 730 for a method of controlling a photonic switching fabric. Initially, in step 732, the packet destination group is determined. This is the group number of the TOR group the packet is destined for. A potential collision may also be detected and resolved by delaying a packet to avoid the collision.

Then, in step 734, the wavelength for the packet is set. This wavelength is based on the packet destination group determined in step 732.

Next, in step 736, output port collisions are detected. In one example, an optical source is selected at the desired wavelength. Alternatively, an optical source is tuned to the desired wavelength. This may take place in the GFCs, which receive communications from the SMCs. When a collision is detected, one address is approved and the others are rejected.

Then, in step 738, the load is balanced across cores. This facilitates that each first stage output and third stage input is only used once.

Finally, in step 740, a connection map is generated. The connection map is generated based on the load balancing performed in step 738.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A photonic switching fabric comprising:
a first stage comprising a plurality of first switches;
a second stage comprising a plurality of second switches, wherein the second stage is optically coupled to the first stage; and
a third stage comprising a plurality of third switches, wherein the third stage is optically coupled to the second stage, wherein the photonic switching fabric is configured to receive a packet having a destination address, wherein the destination address comprises a group destination address, and wherein the second stage is configured to be connected in accordance with the group destination address.

2. The photonic switching fabric of claim 1, wherein the group destination address is a location of a third stage switch of the plurality of third switches.

3. The photonic switching fabric of claim 1, wherein the plurality of second switches comprises a plurality of arrayed waveguide grating routers (AWG-R).

4. The photonic switching fabric of claim 3, further comprising setting connectivity of the plurality of AWG-Rs comprising selecting a wavelength in accordance with the group destination address.

5. The photonic switching fabric of claim 1, wherein a container comprises a synchronous frame comprising a first packet in a first input port, a second packet in a second input port, and a header, wherein the header comprises the destination address.

6. The photonic switching fabric of claim 1, wherein the packet comprises:
a packet sequence number;
a source TOR (Top of Rack) group address;
an individual source TOR address within a source TOR group; and
an individual destination TOR address within a destination TOR group.

7. The photonic switching fabric of claim 1, further comprising:
the photonic switching fabric;
a traffic splitter coupled to the photonic switching fabric;
an electrical switching fabric coupled to the traffic splitter; and
a traffic combiner coupled to the photonic switching fabric and the electrical switching fabric.

8. The photonic switching fabric of claim 1, further comprising:
a first source matrix controller coupled to the first stage;
a second source matrix controller coupled to the first stage;
a first group fan-in controller coupled to the third stage;
a second group fan-in controller coupled to the third stage; and
an orthogonal mapper coupled to the first source matrix controller, the second source matrix controller, the first group fan-in controller, and the second group fan-in controller.

9. A method of controlling a photonic switch, the method comprising:
identifying a destination group of a packet;
selecting a wavelength for the packet in accordance with the destination group of the packet; and
detecting an output port collision between the packet and another packet after determining the wavelength for the packet.

10. The method of claim 9, wherein selecting the wavelength of the packet comprises tuning a wavelength source.

11. The method of claim 9, wherein selecting the wavelength for the packet comprises connecting a wavelength source of a bank of wavelength sources to the photonic switch by an optical selector.

12. The method of claim 9, further comprising:
determining whether a length of the packet is greater than a threshold; and
electrically switching the packet when the length of the packet is less than the threshold; and
optically switching the packet when the length of the packet is greater than or equal to the threshold.

13. The method of claim 9, further comprising padding the packet by a buffer when the packet is above a threshold and below a maximum size to produce a padded packet.

14. The method of claim 13, further comprising:
determining a buffer length;
determining an output clock rate in accordance with a traffic requirement and a probability of overflow of the buffer; and
reading a dummy packet from the buffer when an output memory number is within a first distance from an input memory number, wherein padding the packet comprises reading the packet into the buffer having the buffer length at an input clock rate and reading the padded packet out of the buffer at the output clock rate, and wherein the output clock rate is faster than the input clock rate.

15. The method of claim 13, wherein a padded length of the padded packet is 1500 bytes.

16. The method of claim 13, further comprising:
optically switching the packet; and
un-padding the packet.

17. The method of claim 9, further comprising:
optically switching the packet;
delaying the another packet to produce a delayed packet;
optically switching the delayed packet; and
combining the packet and the another packet, wherein an order of the packet and the another packet is maintained in accordance with a packet sequence number of the packet and another packet sequence number of the another packet.

18. The method of claim 9, wherein the another packet has another destination group, wherein the destination group is the same as the another destination group.

19. The method of claim 9, further comprising:
balancing loads across a plurality of arrayed waveguide gratings (AWG-Rs); and
generating a connection map.

20. The method of claim 19, further comprising adjusting connections in a switching stage in accordance with the connection map.

21. The method of claim 9, further comprising:
determining a packet phase of the packet at an input to the photonic switch;
generating a switch clock frame having a clock phase;
comparing the packet phase at a switch input to the clock phase to produce phase comparison;
transmitting the phase comparison; and
adjusting timing of a packet source clock in accordance with the phase comparison.

22. The method of claim 9, further comprising:
identifying another destination group of the another packet; and
selecting another wavelength for the another packet in accordance with the another destination group of the another packet.

23. A method of generating a connection map for a photonic switching fabric, the method comprising:
performing a first step of connection map generation for a first packet to produce a first output;
performing a second step of connection map generation for the first packet in accordance with the first output to produce a second output after performing the first step of connection map generation for the first packet; and
performing the first step of connection map generation for a second packet at the same time as performing the second step of connection map generation for the first packet.

24. The method of claim 23, wherein performing the first step of connection map generation for the first packet takes less than or equal to a frame period and performing the second step of connection map generation takes less than or equal to the frame period.

25. The method of claim 23, further comprising transmitting a connection map step to an orthogonal mapper.

26. The method of claim 23, wherein the first step comprises determining a destination top-of-rack (TOR) group for the first packet, wherein the second step comprises determining a wavelength in accordance with the TOR group, the method further comprising:
detecting output port collisions after performing the second step;
balancing loads in a plurality of switches after detecting output port collisions; and
determining connections for the plurality of switches.

27. A photonic switching system comprising:
a first input stage switching module;
a first control module coupled to the first input stage switching module, wherein the first control module is configured to control the first input stage switching module;
a second input stage switching module;
a second control module coupled to the second input switching module, wherein the second control module is configured to control the second input stage switching module;
a first output stage switching module;
a third control module coupled to the output stage switching module, wherein the third control module is configured to control the first output stage switching module;
a second output stage switching module;
a fourth control module coupled to the second output stage switching module, wherein the fourth control module is configured to control the second output stage switching module; and
an orthogonal mapper coupled between the first control module, the second control module, the third control module, and the fourth control module.

28. The photonic switching system of claim 27, wherein the first control module comprises a first pipelined control module, the second control module comprises a second pipelined control module, the third control module comprises a third pipelined control module, and the fourth control module comprises a fourth pipelined control module.

29. The photonic switching system of claim 27, wherein the orthogonal mapper comprises:
a first orthogonal mapper module, wherein the first orthogonal mapper module is configured to pass a first message from the first control module to the third control module, a second message from the first control module to the fourth control module, a third message from the second control module to the third control module, and a fourth message from the second control module to the fourth control module; and
a second orthogonal mapper module, wherein the second orthogonal mapper module is configured to pass a fifth message from the third control module to the first control module, a sixth message from the third control module to the second control module, a seventh message from the fourth control module to the first control module, and an eighth message from the fourth control module to the second control module.
